(19) United States
(12) Patent Application Publication
(10) Pub. No.: US 2022/0343167 A1
(43) Pub. Date: Oct. 27, 2022

(54) METHODS AND APPARATUS FOR MACHINE LEARNING MODEL LIFE CYCLE

(71) Applicant: Telefonaktiebolaget LM Ericsson (publ), Stockholm (SE)

(72) Inventors: Deepa CHAWLA, Sundbyberg (SE); Gaurav DIXIT, Sollentuna (SE); Wenfeng HU, Täby (SE); Selim ICKIN, Stocksund (SE); Farnaz MORADI, Stockholm (SE); Erik SANDERS, Vallentuna (SE); Saurabh SINGH, Vallentuna (SE); Jalil TAGHIA, Stockholm (SE); Konstantinos VANDIKAS, Solna (SE)

(21) Appl. No.: 17/774,201

(22) PCT Filed: Oct. 30, 2020
(86) PCT No.: PCT/EP2020/080535

§ 371 Date: May 4, 2022

Related U.S. Application Data
(60) Provisional application No. 62/930,637, filed on Nov. 5, 2019.

(51) Int. Cl. G06N 3/08

(52) U.S. Cl. CPC G06N 3/08

(57) ABSTRACT

A method of performing federated feature selection for a machine learning model in a federated learning environment includes obtaining, at a first resolution, a global set of selector neural network weights. At a second resolution, the method selects, for a plurality of first data subsets, a first set of features from a feature space by iteratively applying a first selector neural network that is initialized with the global set of selector neural network weights to the first data subset to obtain a first set of selector neural network weights. The first data subsets are divided into a plurality of second data subsets, and, at a third resolution, a second set of features is selected from the feature space.

### TECHNICAL FIELD

The present application relates to machine learning, and in particular to federated learning systems.

### BACKGROUND

In the telecommunications industry it is becoming increasingly challenging to perform machine learning across multiple operators, since access to data is heavily restricted. Different operators form their own separate administrative domains, and as such, they maintain their own datasets in public or private data centers. Some operators may develop their own machine learning models, while others may share a portion with a third-party, such as a vendor. In the latter case, a joint approach may combine the strengths of the vendor and the operator. In particular, a machine learning model may be created for later deployment by the operator who owns the original dataset. Since relevant data for this model is generated within that data center, the model remains there as a computational model. The model may be periodically retrained to better adjust to changes in the distribution associated with the phenomenon it is designed to predict.

Deploying models across different systems presents a number of challenges. For example, in a training phase, models created this way may be limited to their local information and may not benefit from other similar datasets that have been collected in another data center under the jurisdiction or ownership of another operator. Data transfer can be expensive if the model needs data that are generated in other nodes outside of the data center.

In an inference phase, models are running in their corresponding data centers. Connectivity to data centers is not always optimal. Thus, when a request is made for inference from a remote client, it may take a significant amount of time for the request to be fulfilled.

Features for each model may be manually selected, and as such may not make sense across multiple operators due to lack of semantics, incorrect implementation of standards, and/or lack of relevance with regards to a predicted label for a given predictive task.

Many of these challenges are addressed by a technique called Federated Learning (FL). A Federated Learning system 100 is illustrated in FIG. 1. In an FL system 100, a centralized server 100, known as master or master entity, is responsible for maintaining a global model 105 which is created by aggregating the models/weights which are trained in an iterative process at participating nodes/clients 120, known as workers or worker entities, using local data.

FL depends on continuous participation of workers 120 in an iterative process for training of the model 105 and communicating the model weights with the master 110. The master 110 can communicate with different number of workers 120 ranging between tens to millions, and the size of model weight updates which are communicated can range between kilobytes to tens of megabytes.

### REFERENCES

[1] H Brendan McMahan, Eider Moore, Daniel Ramage, Seth Hampson, Blaise Agüera y Arcas, “Communication-efficient learning of deep networks from decentralized data”, in Proceedings of the 20th International Conference on Artificial Intelligence and Statistics (AISTATS), 2017.
[2] N. Malpani, J. L. Welch, and N. Vaidya, “Leader election algorithms for mobile ad hoc networks,” in Proceedings of the 4th international workshop on Discrete algorithms and methods for mobile computing and communications. ACM, 2000, pp. 96-103
[3] Keith Bonawitz, Hubert Eichner, Wolfgang Grieskamp, Dzmitry Huba, Alex Ingerman, Vladimir Ivanov, Chloe Kiddon, Jakub Konecny, Stefano Mazzocchi, H. Brendan McMahan, Timon Van Overveldt, David Petrou, Daniel Ramage, Jason Roselander “Towards Federated Learning at Scale design.”
[4] Nishio, T. and Yonetani, R. Client selection for federated learning with heterogeneous resources in mobile edge. arXiv preprint arXiv:1804.08333, 2018
[5] Konstantinos Vandikas, Selim Ickin, Gaurav Dixit, Michael Buisman, Jonas Akeson, (2019)“Privacy-aware machine learning with low network footprint.”
[6] Balin, M. F., Abid, A., & Zou, J Y. (2019). Concrete Autoencoders: Differentiable Feature Selection and Reconstruction. ICML.
[7] Maddison, C. J., Mnih, A., & Teh, Y. W. (2016). The Concrete Distribution: A Continuous Relaxation of Discrete Random Variables. ICLR.

### SUMMARY

Some embodiments described herein address one or more of the challenges associated with Federated Learning. In particular, some embodiments described herein address one or more of these challenges via federated feature selection, federated model fine tuning, and/or dynamic selection of computation resources for a federated model.

In particular, some embodiments provide more accurate and/or efficient selection of features in a Federated Learning system by providing multi-resolution feature selection and/or federated ranking of features. Some further embodiments provide more accurate and/or efficient tuning of Federated Learning systems and selection of topologies for Federated Learning systems.

A method of performing federated feature selection for a machine learning model in a federated learning environment includes obtaining, at a first resolution, a global set of selector neural network weights. At a second resolution, the method selects, for a plurality of first data subsets of a data set of data samples extracted from a system to be modeled, wherein the data samples are associated with features in a feature space of the system, a first set of features from the feature space by iteratively applying a first selector neural network that is initialized with the global set of selector neural network weights to the first data subset to obtain a first set of selector neural network weights. The method divides the first data subsets into a plurality of second data subsets, and, at a third resolution, for respective ones of the plurality of second data subsets, selects a second set of features from the feature space. For respective ones of the plurality of second data subsets, selecting the second set of features includes iteratively applying a second selector neural network that is initialized with the first set of selector neural network weights to the second data subset to obtain a second set of selector neural network weights.

The method may further include providing selector neural network weights from a highest resolution to the first resolution.

Obtaining the global set of weights may include, at the first resolution, averaging the selector neural network weights provided by the selector neural networks at the highest resolution.

Selecting the set of features may include applying the selector neural network to the data set of data samples using a preliminary set of neural network weights to obtain a preliminary set of features, generating a reconstructed set of data samples from the preliminary set of features using a decoder neural network, generating a loss metric based on a difference between the set of original data samples and the set of reconstructed data samples, and updating the preliminary set of neural network weights to obtain an updated set of neural network weights based on the loss metric.

The steps of applying the selector network to the data set of data samples, generating the reconstructed set of data samples, generating the loss metric and updating the preliminary set of neural network weights may be repeated until the updated set of neural network weights converges.

The federated learning environment may include a master entity and a plurality of worker entities. Obtaining the global set of selector neural network weights may be performed by the master entity. Selecting the first set of features from the feature space at the second resolution may be performed by the worker entities given the global weights from the master entity.

Dividing the data set into the plurality of first data sets may be performed in a random fashion and/or a determinative fashion. In some embodiments, dividing the data set into the plurality of first data sets is performed by dividing the data set into operator-specific sub sets.

The method may further include averaging the second sets of selector neural network weights to obtain an averaged set of selector neural network weights, and repeating operations of selecting a set of features from the feature space by iteratively applying the first selector neural network to the data set starting with the averaged set of selector neural network weights.

A federated learning entity according to some embodiments includes a processing circuit and a memory coupled to the processing circuit. The memory includes computer readable program instructions that, when executed by the processing circuit, cause the federated learning entity to perform operations of obtaining, at a first resolution, a global set of selector neural network weights and selecting, at a second resolution, for a plurality of first data subsets of a data set of data samples extracted from a system to be modeled, a first set of features from the feature space by iteratively applying a first selector neural network that is initialized with the global set of selector neural network weights to the first data subset to obtain a first set of selector neural network weights. The data samples are associated with features in a feature space of the system.

The operations further include dividing the first data subsets into a plurality of second data subsets, and selecting, at a third resolution, for respective ones of the plurality of second data subsets, a second set of features from the feature space. For respective ones of the plurality of second data subsets, selecting the second set of features includes iteratively applying a second selector neural network that is initialized with the first set of selector neural network weights to the second data subset to obtain a second set of selector neural network weights.

Some embodiments provide a federated learning entity that is configured to select, at a first resolution, to obtain a global set of selector neural network weights, and to select, at a second resolution, for respective ones of a plurality of first data subsets of a data set of data samples extracted from a system to be modeled, wherein the data samples are associated with features in a feature space of the system, a first set of features from the feature space by iteratively applying a first selector neural network that is initialized with the global set of selector neural network weights to the first data subset to obtain a first set of selector neural network weights.

The federated learning entity is further configured to divide the first data subsets into a plurality of second data subsets, and to select, at a third resolution, for respective ones of the plurality of second data subsets, a second set of features from the feature space, wherein, for respective ones of the plurality of second data subsets, selecting the second set of features comprises iteratively applying a second selector neural network that is initialized with the first set of selector neural network weights to the second data subset to obtain a second set of selector neural network weights.

A method of performing feature selection in a federated learning system according to some embodiments includes receiving, at a master entity, from respective ones of a plurality of worker entities, a ranked list of features based on a subset of data samples associated with the worker entity, and ranking the features based on the ranked lists to obtain a master ranked list of features/The master entity transmits the master ranked list of features to the plurality of worker entities for training a respective neural network using their respective subset of data samples. The features may be selected from a feature space of a system to be modeled.

Ranking the features may include identifying features that are common to the ranked lists. Generating the ranked list of features may include applying a random forest procedure to the features. In some embodiments, the features may be ranked based on frequency of appearance and/or ranking of the features in the ranked lists.

The method may further include receiving, from respective ones of the plurality of worker entities, an accuracy value that measures accuracy of the neural network trained using the master ranked list of features, receiving, from respective ones of the plurality of worker entities, a model configuration that comprises a number of model layers and a set of features of the neural network trained using the master ranked list of features, generating an updated master ranked list of features using Reinforcement Learning based on model configurations and accuracies, and transmitting the updated master ranked list of features to the plurality of worker entities.

A federated learning entity according to some embodiments includes a processing circuit and a memory coupled to the processing circuit. The memory includes computer readable program instructions that, when executed by the processing circuit, cause the federated learning entity to perform operations of receiving, at a master entity, from a plurality of worker entities, a ranked list of features based on a subset of data samples associated with the worker entity. The master entity ranks the features based on the ranked lists to obtain a master ranked list of features, and transmits the master ranked list of features to the plurality of worker entities for training a respective neural network using their respective subset of data samples.

A federated learning entity according to some embodiments is configured to receive, at a master entity, from a plurality of worker entities, a ranked list of features based on a subset of data samples associated with the worker entity, at the master entity, rank the features based on the ranked lists to obtain a master ranked list of features, and transmit the master ranked list of features to the plurality of worker entities for training a respective neural network using their respective subset of data samples.

A method of performing feature selection in a federated learning system according to some embodiments includes selecting, at a worker entity, a first set of features from a feature space of a system to be modeled, generating a ranked list of the selected features based on a subset of data samples associated with the worker entity, transmitting the ranked list of features to a master entity, receiving a master ranked list of features from the master entity, and training a neural network using the subset of data samples and the master ranked list of features.

The method may further include calculating an accuracy of the neural network training, and transmitting the accuracy to the master entity.

The method may further include generating a model configuration comprising a number of model layers and a set of features, and transmitting the model configuration to the master entity.

In some embodiments, a reinforcement learning agent generates a model configuration that maximizes mean worker accuracy, minimizes variance of worker accuracy, minimizes neural network size, and minimizes feature size.

The method may further include evaluating the accuracy of the neural network training using reinforcement learning with the following reward formula:

Reward=MeanAccuracy/(epsilon+(VarianceAccuracy+Σₗ₌^{L}n_{i,l}))

where n_{i,1} is a number of neurons in layer l of worker i, epsilon is a small value, MeanAccuracy is the mean accuracy of the neural network, VarianceAccuracy is the accuracy variance of the neural network, and L is an upper boundary for the layer count in a reinforcement learning exploration phase.

A federated learning entity according to some embodiments includes a processing circuit and a memory coupled to the processing circuit. The memory includes computer readable program instructions that, when executed by the processing circuit, cause the federated learning entity to perform operations of selecting a first set of features from a feature space of a system to be modeled, and generating a ranked list of the selected features based on a subset of data samples associated with the worker entity. The entity transmits the ranked list of features to a master entity and receives a master ranked list of features from the master entity. The entity trains a neural network using the subset of data samples and the master ranked list of features.

A federated learning entity according to some embodiments is configured to select, at a worker entity, a first set of features from a feature space of a system to be modeled, generate a ranked list of the selected features based on a subset of data samples associated with the worker entity, transmit the ranked list of features to a master entity, receive a master ranked list of features from the master entity, and train a neural network using the subset of data samples and the master ranked list of features.

A method of training a neural network at a worker entity in a federated learning system according to some embodiments includes receiving a set of model weights from a master entity and training the neural network model using the set of model weights to obtain a set of modified model weights. The performance of the model is evaluated, and it is determined whether the performance of the model has improved or degraded relative to a previous performance of the model following a previous training round of training neural networks in the federated learning system. In response to determining that the performance of the model has improved relative to the previous performance of the model following the previous training rounds, the method transmits the modified model weights to the master entity for federation by the master entity and selecting the modified model weights for use in operating the neural network.

Evaluating the performance of the model may include evaluating the performance of the model against local validation data that is local to the worker entity.

The method may further include, in response to determining that the performance of the model has degraded relative to the previous performance of the model following the previous training round, determining whether a level of performance degradation is less than a threshold, and, in response to determining that the level of performance degradation is less than the threshold, transmitting the modified model weights to the master entity for federation by the master entity and selecting the modified model weights for use in operating the neural network.

The method may further include, in response to determining that the level of performance degradation is greater than the threshold, transmitting a previous set of model weights generated in connection with the previous training round to the master entity for federation by the master entity, and selecting the previous set of model weights for use in operating the neural network.

The method may further include, in response determining that the level of performance has degraded relative to the previous performance of the model following the previous training round, determining whether or not to participate in future rounds of training neural networks in the federated learning system.

The method may further include receiving a set of final model weights from the master entity, evaluating the performance of the neural network using the final model weights, re-training the neural network starting with the final model weights to obtain modified final model weights, evaluating the performance of the neural network using the modified final model weights, comparing performance of the neural network using the final model weights to performance of the neural network using the modified final neural network weights, and selecting a set of neural network weights from among the final neural network weights and the modified final neural network weights in response to the comparison.

The method may further include comparing performance of the neural network using the final model weights to performance of the neural network using the modified final neural network weights and intermediate sets of neural network weights generated during a federated learning round, and selecting a set of neural network weights from among the final neural network weights, the modified final neural network weights and the intermediate neural network weights in response to the comparison.

The method may further include combining the final neural network weights with the modified final neural network weights and/or one or more sets of intermediate neural network weights to obtain a combined set of neural network weights, and operating the neural network using the combined set of neural network weights.

In some embodiments, combining the first neural network weights with the modified final neural network weights and/or one or more sets of intermediate neural network weights may include generating a weighted average of the first neural network weights and the modified final neural network weights and/or one or more sets of intermediate neural network weights.

A federated learning entity according to some embodiments includes a processing circuit and a memory coupled to the processing circuit. The memory includes computer readable program instructions that, when executed by the processing circuit, cause the federated learning entity to perform operations of receiving a set of model weights from a master entity and training the neural network model using the set of model weights to obtain a set of modified model weights. The entity evaluates performance of the model and determines whether the performance of the model has improved or degraded relative to a previous performance of the model following a previous training round of training neural networks in the federated learning system. In response to determining that the performance of the model has improved relative to the previous performance of the model following the previous training rounds, the entity transmits the modified model weights to the master entity for federation by the master entity and selects the modified model weights for use in operating the neural network.

A federated learning entity according to some embodiments is configured to receive a set of model weights from a master entity and train the neural network model using the set of model weights to obtain a set of modified model weights. The entity evaluates performance of the model to determine whether the performance of the model has improved or degraded relative to a previous performance of the model following a previous training round of training neural networks in the federated learning system, and in response to determining that the performance of the model has improved relative to the previous performance of the model following the previous training rounds, transmits the modified model weights to the master entity for federation by the master entity and selects the modified model weights for use in operating the neural network.

A method of generating a federated learning topology including a plurality of worker entities for training a neural network includes generating a plurality of different topologies for a federated learning system, wherein the federated learning system includes the plurality of worker entities. For the plurality of topologies, the method estimates a cost of operating the federated learning system using the topology and selects a subset of the topologies based on the estimated cost. The method determines whether the topologies in the selected subset of topologies can be instantiated, and selects a topology for implementation based on the determination of whether the topologies in the selected subset of topologies can be instantiated.

The cost of operating the federated learning system using a selected topology may be estimated by estimating a cost of data transfer associated with the selected topology.

In some embodiments, estimating the cost of operating the federated learning system using a selected topology may be performed by estimating a computer performance metric associated with the selected topology.

In some embodiments, estimating the computer performance metric may be performed by estimating, for a layer in the neural network, a number of floating point operations per second, FLOPS, needed based on a scalar product operation on the layer.

In some embodiments, estimating the number of FLOPS associated with the selected topology includes estimating the number of FLOPS according to the following formula for a layer in the neural network:

2*m*N(l+1)*[Nl+1] FLOPS per layer

where m is a number of samples in a data set processed by the neural network and N(l) is a layer size of the neural network.

The method may further include generating a network footprint associated with each topology, and estimating an availability of resources needed to implement the network footprint associated with the topology.

The method may further include estimating an availability of resources needed to obtain the computer performance metric associated with the selected topology.

The topology may be one of a centralized training topology, an isolated training topology, a federated training topology, a round robin topology and a hierarchical topology.

The method may further include determining that the selected topology is no longer sustainable; selecting a different topology for instantiation; and instantiating the different topology. The different topology may be selected based on a cost of the different topology and an ability of the different topology to be instantiated. Determining that the selected topology is no longer sustainable may include determining that the selected topology is no longer sustainable based on cost and/or available resources.

A computing device according to some embodiments includes a processing circuit and a memory coupled to the processing circuit. The memory includes computer readable program instructions that, when executed by the processing circuit, cause the computing device to generate a plurality of different topologies for a federated learning system that includes s plurality of worker entities and estimate a cost of operating the federated learning system using each topology. The computing device selects a subset of the topologies based on the estimated cost, determines whether the topologies in the selected subset of topologies can be instantiated, and selects a topology for implementation based on the determination of whether the topologies in the selected subset of topologies can be instantiated.

A computing device according to some embodiments is configured to generate a plurality of different topologies for a federated learning system that includes a plurality of worker entities, and estimate a cost of operating the federated learning system using each topology. The device selects a subset of the topologies based on the estimated cost, determines whether the topologies in the selected subset of topologies can be instantiated, and selects a topology for implementation based on the determination of whether the topologies in the selected subset of topologies can be instantiated.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a Federated Learning system including a master entity and one or more worker entities.

FIG. 2 illustrates various functional aspects of a master entity and a worker entity in a Federated Learning system.

FIG. 3 illustrates a Federated Learning sequence involving a master and multiple workers that may be followed according to some embodiments.

FIG. 4 illustrates multi-resolution federated feature selection according to some embodiments.

FIG. 5 is a flowchart of operations for multi-resolution federated feature selection according to some embodiments.

FIGS. 6A and 6B are flowcharts of operations for feature selection with ranking according to some embodiments.

FIG. 6C is a flow diagram illustrating operations of a Federated Learning system according to some embodiments.

FIGS. 7A and 7B are flowchart of operations for federated model fine tuning according to some embodiments.

FIG. 8 is a flow diagram illustrating federated model fine tuning according to some embodiments.

FIG. 9 illustrates various Federated Learning topologies that may be considered for a FL system.

FIGS. 10A and 10B illustrate example topologies that can be generated for Federated Learning systems according to some embodiments.

FIG. 10C illustrates a process for switching between topologies.

FIG. 11 is a flow diagram that illustrates dynamic federation formation according to some embodiments.

FIG. 12 is a flowchart of operations for dynamic federation formation according to some embodiments.

FIG. 13 is a block diagram illustrating a worker node/non-leader device according to some embodiments of inventive concepts.

FIG. 14 is a block diagram illustrating a master node/leader computing device according to some embodiments of inventive concepts.

FIG. 15 is a block diagram of a wireless network in accordance with some embodiments.

FIG. 16 is a block diagram of a user equipment in accordance with some embodiments.

FIG. 17 is a block diagram of a virtualization environment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As noted above, Federated Learning (FL) is an approach that can be used to train models for use on different systems. However, the model lifecycle that is typically used for federated learning may be rigid, since:

1) It is does not allow for a new worker to join an active federation. New workers can only be onboarded during the selection process.

2) It does not address the feature selection problem, as different features may not have equal importance to all operators.

3) The product of the federation is a federated averaged model which may fail at matching individual operator characteristics while trying to capture the characteristics of all operators.

4) Even though federated learning can run on any type of device (e.g., mobile device, base station, network node, etc.), it typically assumes that all devices have equal capabilities and may not take into consideration data transfer costs that may be incurred while a federation takes place. As such, federations can only follow a very rigid master to worker cycle which can be limited in some cases.

5) Federated Learning generates a federated model. While this may make sense from a long-term perspective, there are cases where isolated training or even centralized training could yield better performance.

Some embodiments described herein address one or more of the challenges associated with Federated Learning. In particular, some embodiments described herein address one or more of these challenges via federated feature selection, federated model fine tuning, and/or dynamic selection of computation resources for a federated model.

Federated feature selection involves selection of system features for inclusion in a neural network. Model fine tuning involves tuning a local model using federated information supplied by a master entity. Dynamic selection of computation resources for a federated model may involve calculating or estimating memory requirements, processing power (e.g., floating point operations per second, or FLOPS), availability of resources, and network data transfer resources to create a computational topology of an FL model for training/inference. Depending on the capability/availability of different devices, decisions may be made to federate or not to federate, to pretrain, not pretrain, fallback to more specific models, etc.

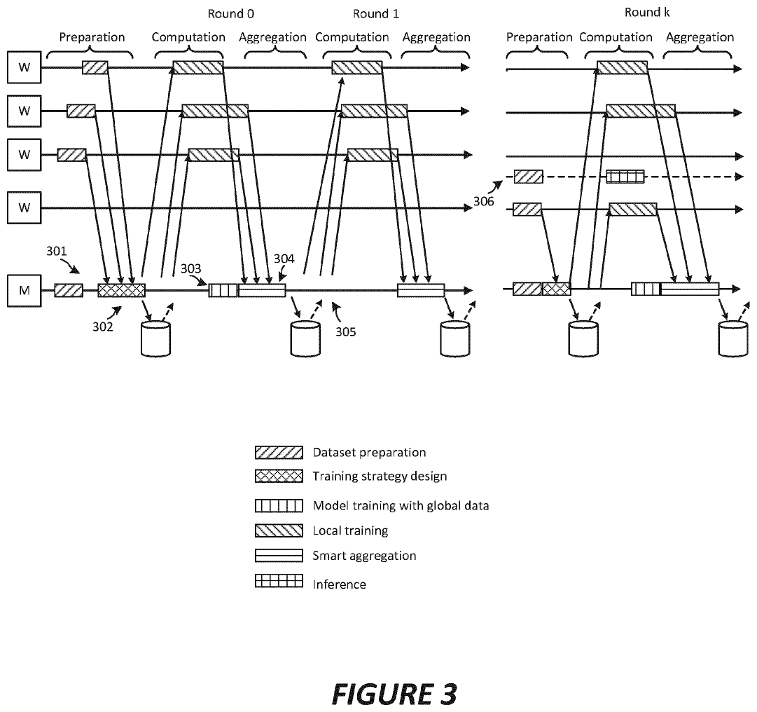

FIG. 2 illustrates various functional aspects of a master entity and a worker entity in a Federated Learning system. In particular, FIG. 2 illustrates a logical arrangement of functions within a master entity 110 and a worker entity 120. Each box may be a containerized micro-service running in a Kubernetes (k8s) cluster. The master entity 110 may include components running in a provider hub, while the worker entity 120 may include components running in a customer premises. However, in some cases, both the master and worker entities may be operated by a single entity.

The master entity 110 includes a GIT function that can be used to access a GIT repository, a continuous integration and continuous delivery (Cl/CD) function, a master docker registration function, a master database DB-M, and a master integration function INT-M. The worker entity 120 includes a worker docker image, a prediction/performance database function, a worker integration function INT-W and a worker database DB-W. Global model parameters may be stored in the master database DB-M, while local model parameters may be stored in the worker database DB-W.

FL_M and FL_W are the Federated Learning services in the master 110 and worker 120 entities, respectively. FL_API is the triggering pipeline that receives FL requests (with metadata) and instantiates the FL services FL_M and FL_W(s).

Under the master branch there are different use case specific folders that provide access to K8s cluster, job manifests, on-demand or scheduled tasks and authentication. Authentication may be token-based (constant) generated by IDM authority. The FL_API may receive input from the Integration function INT_M, such as model name, model version, and operator name(s) and access tokens to instantiate FL workers.

The FL_API may output a GIT function triggering pipeline that instantiates the FL_M and FL_W services to start the federated learning procedure.

The FL_M is the orchestrater of the federated learning procedure. Logically, it may contain three major functionalities, namely, training strategy, FL master functionality and model storage.

The FL_M may implement a training strategy agent that performs federated feature selection for specific use cases, training strategy design including choosing hyperparameters, activating model fine tuning, etc., and dynamic selection of computation resources for a federated model.

The FL_M may further implement an FL_master agent that initiates neural network (NN) weights, shares the weights to the FL_W, and averages the weights that have been trained locally by the FL_Ws. Averaging of the weights provided by FL_Ws may be an iterative process continues until the model performance saturates.

The model storage functionality commits the learnings to a GIT repository. At the end of an FL procedure, the following items will be committed by FL_M to the repository:

1) Federated average model weights that can be used for next new worker onboarding and/or initial weights for the next FL procedure.

2) ‘Fine-tuned’ model weights for each worker.

3) A normalization vector that model pipeline could use to normalize input features before calling model prediction service, which may be wrapped into model containers.

4) A cut-off threshold that can be used to translate the probability of classes (last layer of NN) into binary decision.

The FL_W function acts as worker in the federated learning process. It contains two functionalities, local dataset distribution estimation and federated training. Federated training is performed together with the FL_M following the strategy provided by the training strategy agent in FL_M.

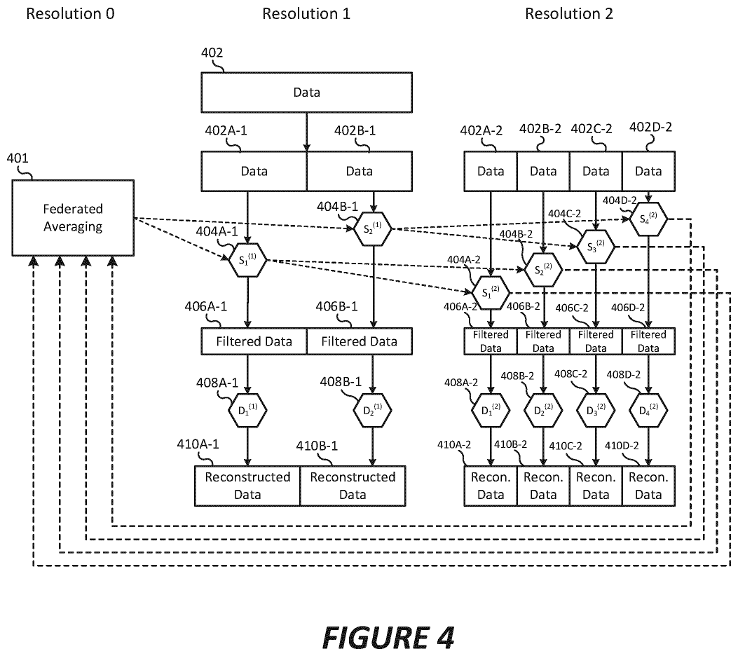

FIG. 3 illustrates a Federated Learning sequence involving a master and multiple workers that may be followed according to some embodiments. In particular, FIG. 3 illustrates a sequence diagram from model registration to model onboarding, serving and retraining in a federated learning fashion. As shown therein, local datasets transmitted to the master for dataset preparation 301. Training strategy design occurs at a dataset characteristic checkpoint 302. Model parameters are then provided to the workers, which perform local training in a first round (Round 0) and provide updated parameters to the master. The master performs model training with global data 303 followed by smart aggregation 304 with the local parameters. The revised model is then provided to the workers for local training in a subsequent round (Round 1). The computation/aggregation cycle continues until the master generates a final set of weights in a kth round. A worker can join in a later round by inferring the model parameters 306.

Feature Selection

Some embodiments described herein address the issue of feature selection in a Federated Learning system. Feature selection is not to be confused with the feature representation learning. In feature selection, a set of features is selected from a target feature space. The target feature space contains features, parameters, etc., related to a system of interest. For example, in a wireless telecommunication system, the feature space may include information such as channel quality information, channel statistics, bandwidth, latency, SINR, etc.

A neural network receives features of a system of interest as inputs, processes the features, and produces an output that can be used for decision-making or control relating to the system of interest. Feature selection is the process of determining which features to use as inputs to the neural network. The selection of an excessive number of features might adversely affect the network footprint during a training phase of an FL system, since the size of the neural network (or the network foot print) that is being shared between entities increases with the size of the feature set. The goal of FL is to maximize the individual accuracy of the neural network models running on the worker nodes while keeping the neural network size being shared between the workers and the master node as small as possible. Therefore, there is a need to address the trade-off between the number of features used and the accuracy of the resulting models.

Existing feature selection methods may be broadly divided into three groups: filter, wrapper, and embedded methods. Filter methods define criteria based on certain statistical tests, such as variance. Then they rank the features of the dataset by features that individually maximize the desired criteria. In the standard formulation, the filter methods do not consider interactions between features.

In contrast to the filter methods, the wrapper methods select subsets of features that maximize some criteria optimized over the selected subset of input features. The optimization method is usually based on black-box sequential search techniques or genetic search algorithms. The wrapper methods can detect potential relationships between features; however, such an approach may increase computational complexity, which greatly limits their applicability to high-dimensional problems.

As in the wrapper methods, embedded methods also consider relationships between features, but generally do so more efficiently by incorporating regularizations, such as the L1-regularization in Lasso. The key idea behind embedded feature selection techniques is to start off with learning feature representations, and then gradually transform to feature selection by varying the strength of the regularization during learning and enforcing sparsification.

The majority of existing embedding techniques are based on simple linear regression models that have limited modeling capabilities, which results in poor generalization. The limited model expressiveness also means that these methods fail to take advantage of the availability of data. Recent advances in deep learning have reintroduced neural networks as nonlinear models with great model expressiveness capabilities. A recent line of research in this regard is inspired by the success of autoencoders as effective nonlinear models for learning representations. The resulting model is referred to as the CONCRETE (continuous relaxation of discrete variables) autoencoder or the autoselector. The autoselector acts similar to an autoencoder with the key difference that the encoder neural network is replaced by a selector neural network, which essentially selects the features as opposed to coding them. However, just as in the autoencoder, it uses a standard neural network as the decoder.

The concrete selector neural network uses a regularization parameter, called temperature, which has the important task of transforming an encoder layer into a selector layer by transforming continuous latent variable into a discrete one-hot variable through the use of concrete latent variables. During the training phase, the temperature of the concrete selector network is gradually decreased, which encourages a user-specified number of discrete features to be learned. During test phase, the selected features can be used with the decoder network to reconstruct the remaining input features.

The main limitation of this feature selection technique is that it primarily takes into account the global structure in the data and discards the effect of local nonlinearities during selection of the features due to the fact that the selector network is constructed from a single-layer linear neural network. Some embodiments described herein address that limitation. In addition to that, some embodiments provide a hierarchical framework for feature selection which can output features both in the global level and the local levels.

Multi-Resolution Federated Feature Selection

Some embodiments provide methods and apparatus for multiresolution feature selection. Multiresolution feature selection is a locally-informed global feature selection method that allows feature selection at both global and local levels. The multi-resolution feature selection systems/methods described herein are based on a hierarchical application of the autoselector on partitions of data.

In multiresolution feature selection, feature selection is performed at various resolutions starting with a broadest resolution, referred to herein as “resolution zero.” Feature selection is repeated at increasingly narrow resolutions.

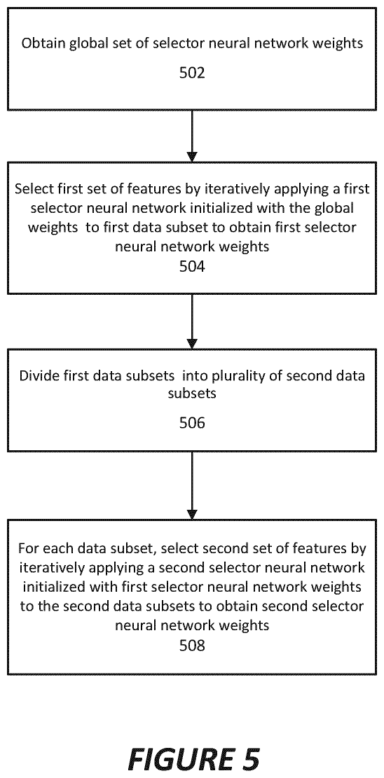

FIG. 4 illustrates multi-resolution federated feature selection according to some embodiments. Referring to FIG. 4, a multiresolution model of maximum resolution 2 is illustrated. Resolution 0 can be considered as the master level. At resolution 1, two workers start a federation with their master from resolution 0. At resolution 2, each one of those workers divides into two parts and starts a new federation with their corresponding masters from resolution 1.

Accordingly, at resolution zero, a global set of weights are obtained by a federated averaging unit 401 which averages the weights from the selector neural networks 404A-2, 404B-2, 404C-2, 404D-2 from the highest resolution (in this example, Resolution 2). At the first iteration, the global weights are initialized randomly or obtained from a pretrained model.

The global set of weights from resolution 0 are transferred to the selector neural networks 404A-1, 404B-1 in the next resolution (Resolution1).

At Resolution 1, given the local datasets 402A-1, 402B-1 derived from a master dataset 402 and the global weights from Resolution 0, the data at each subregion is processed by an autoselector where the selected features are extracted by the respective selector neural network 404A-1, 404B-1 (represented as S₁⁽¹⁾ and S₂(1)) based on both the local data in that subregion and the neural network weights from the previous resolution (which is in this case the global weights from the master). Application of the concrete selector neural networks 404A-1, 404B-1 to the datasets 402A-1, 402B-1 yields filtered datasets 406A-1, 406B-1. The filtered datasets 406A-1, 406B-1 are processed by respective decoder neural networks 408A-1, 408B-1, represented as D₁⁽¹⁾ and D₂⁽¹⁾. Using the selected subset of features, sets of reconstructed data samples 410A-1, 410B-1 are generated by applying the decoder neural networks 408A-1, 408B-1 of the autoselector to the filtered datasets 406A-1, 406B-1.

Information about the selected features at Resolution 1 is transferred to the next resolution (Resolution 2) by transferring the weights of the selector neural network 404A-1 to selector neural networks 404A-2 and 404B-2, and transferring the weights of the selector neural network 404B-1 to selector neural networks 40C-2 and 404D-2 in Resolution 2. Application of the concrete selector neural networks 404A-2, 404B-2, 404C-2, 404D-2 to the datasets 402A-2, 402B21, 402C-2, 402D-2 yields filtered datasets 406A-2, 406B-2, 406C-2, 406D-2. The filtered datasets are processed by respective decoder neural networks 408A-2, 408B-2, 408C-2, 408D-2, represented as D₁⁽²⁾, D₂⁽²⁾, D₃⁽²⁾ and D₄⁽²⁾. Using the selected subset of features, sets of reconstructed data samples 410A-2, 410B-2, 410C-2, 410D-2 are generated by applying the decoder neural networks 408A-2, 408B-2, 408C-2, 408D-2 of the autoselector to the filtered datasets 406A-2, 406B-2, 406C-2, 406D-2.

In the case of a model with higher resolutions than 2, this procedure continues for each successive resolution, where each data subregion is modeled by a different autoselector.

After one pass through all resolutions, the weights from the selector neural networks at the highest resolution are sent to the federated averaging unit 401 at Resolution 0.

The training within the FL system may be performed in an end-to-end scheme or sequentially.

After training phase, features can be harvested at various resolutions where, at each resolution, the system outputs resolution-specific and region-specific feature sets.

Although the system illustrated in FIG. 4 has a resolution of 2, it will be appreciated that the systems/methods described herein can be extended to models with higher resolutions.

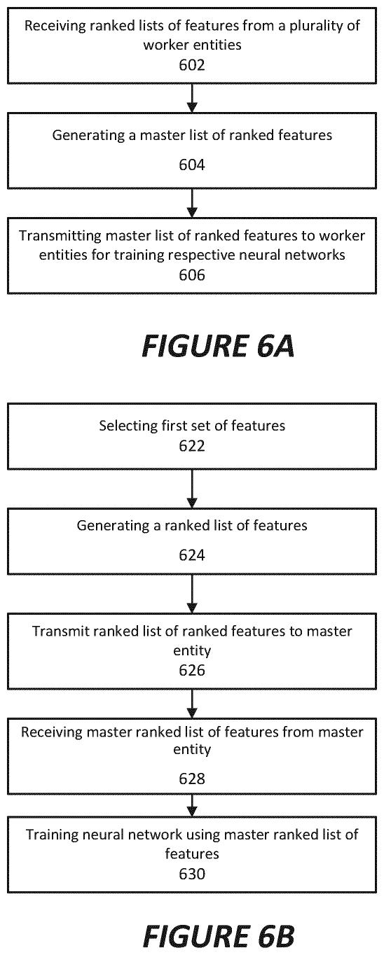

FIG. 5 is a flowchart of operations for multi-resolution federated feature selection according to some embodiments. Referring to FIG. 5, a method of performing federated feature selection for a machine learning model in a federated learning environment includes at a first resolution, obtaining (502) a global set of selector neural network weights. At a second resolution, for each of a plurality of first data subsets of a data set of data samples extracted from a system to be modeled, wherein the data samples are associated with features in a feature space of the system, the method selects (504) a first set of features from the feature space by iteratively applying a first selector neural network that is initialized with the global set of selector neural network weights to the first data subset to obtain a first set of selector neural network weights.

Each of the first data subsets is divided (506) into a plurality of second data sub sets.

At a third resolution, for each of the plurality of second data subsets, a second set of features is selected (508) from the feature space. For each of the plurality of second data subsets, selecting the second set of features includes iteratively applying a second selector neural network that is initialized with the first set of selector neural network weights to the second data subset to obtain a second set of selector neural network weights.

Selecting the set of features may include applying the selector neural network to the data set of data samples using a preliminary set of neural network weights to obtain a preliminary set of features, generating a reconstructed set of data samples from the preliminary set of features using a decoder neural network, generating a loss metric based on a difference between the set of original data samples and the set of reconstructed data samples and updating the preliminary set of neural network weights to obtain an updated set of neural network weights based on the loss metric.

The steps of applying the selector network to the data set of data samples, generating the reconstructed set of data samples, generating the loss metric and updating the preliminary set of neural network weights may be repeated until the updated set of neural network weights converges.

The federated learning environment includes a master entity and a plurality of worker entities.

Obtaining the global set of weights at the first resolution may be performed by the master entity.

Selecting the second set of features from the feature space at the second resolution may be performed by a worker entity.

The method may further include dividing each first data set into a plurality of second data subsets, and at a third resolution, for each of the plurality of second data subsets, selecting a third set of features from the feature space, wherein, for each of the plurality of second data subsets, selecting the third set of features may include iteratively applying a third selector neural network to the second data subset beginning with the second set of selector neural network weights associated with the second data subset, to obtain a third set of selector neural network weights.

The selector neural network may include a continuous relaxation of discrete variables, CONCRETE, neural network.

Dividing the data set into the plurality of first data sets may be performed in a random fashion and/or in a determinative fashion. In some embodiments, the data set may be divided into operator-specific subsets.

The method may further include averaging the second sets of selector neural network weights to obtain an averaged set of selector neural network weights, and repeating operations of selecting a set of features from the feature space by iteratively applying the first selector neural network to the data set starting with the averaged set of selector neural network weights.

Feature Selection with Ranking

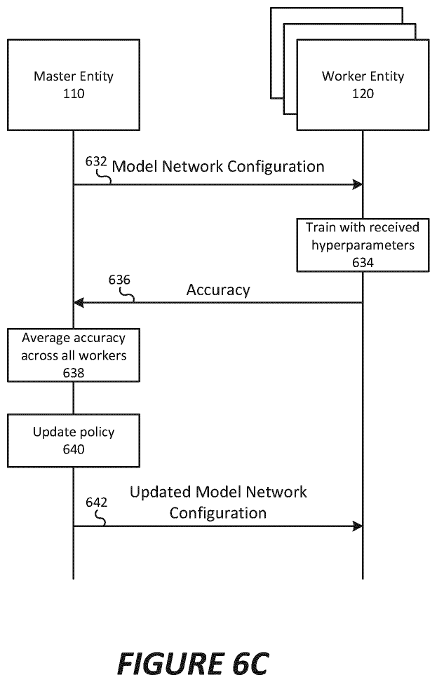

FIG. 6A is a flow diagram illustrating feature selection with ranking according to some embodiments. Some embodiments perform feature selection by a federated ranking process illustrated in FIG. 6A. As shown therein, a method of performing feature selection in a federated learning system includes receiving (block 602), at a master entity, from each of a plurality of worker entities, a ranked list of important features based on a subset of data samples associated with the worker entity, at the master entity, ranking (block 604) the features based on the ranked lists to obtain a master ranked list of features, and transmitting (block 606) the master ranked list of features to the plurality of worker entities for training a respective neural network using their respective subset of data samples.

The features may be selected from a feature space of a system to be modeled.

Ranking the features may include identifying features that may be common to the ranked lists, and may be performed based on frequency of appearance and/or ranking of the features in the ranked lists.

The method may further include receiving, from each of the worker entities, an accuracy value that measures accuracy of the neural network trained using the master ranked list of features, receiving, from each of the worker entities, a model configuration that may include a number of model layers and a set of features of the neural network trained using the master ranked list of features, generating an updated master ranked list of features based on the model configurations and the accuracies, and transmitting the updated master ranked list of features to the worker entities.

Referring to FIG. 6B, a method of performing feature selection in a federated learning system includes selecting (block 622), at a worker entity, a first set of features from a feature space of a system to be modeled, generating (block 624) a ranked list of the selected features based on a subset of data samples associated with the worker entity, transmitting (block 626) the ranked list of features to a master entity, receiving (block 628) a master ranked list of features from the master entity, and training (block 630) a neural network using the subset of data samples and the master ranked list of features.

Generating the ranked list of features may include applying a random forest algorithm to the features.

The method may further include calculating an accuracy of the neural network training, and transmitting the accuracy to the master entity.

The method may further include generating a model configuration comprising a number of model layers and a set of features, and transmitting the model configuration to the master entity.

An example use case for such an embodiment is in next alarm prediction. In a communication network, a network node may periodically receive alarm messages containing alarm data generated by other network nodes. Such alarm messages may be handled by the operations support system (OSS) function as part of network fault management. It may be desirable for a network node to predict the type and frequency of alarm messages that it may receive. A FL agent may be installed at the workers, and an encoding of all alarms (e.g., a dictionary containing the alarm code and alarm name string) is set and sent to all workers. This enables all workers using the same alarm encoding map.

Each worker may choose a set of features that benefits them the most and rank the features in a ranked list, for example, using embedded methods that utilizes filter and wrapper methods. Each worker may run a Random Forest algorithm to identify the most important features. Example important features are depicted in Table 1.

Each worker provides its ranked list to the master. The master receives the ranked list from all workers and uses the ranked lists to identify common features. For example, in Table 1, Feature B is listed in the top important feature list in all network nodes. The ranking in the master may be based on the occurrence of the features in different operators and/or the importance assigned to the features by each of the workers. For example, if a feature occurs on the ranked lists of five workers, then its ranking may be set to 5 by the master. Thus, in an example features may be ranked as follows: [Feature B (rank 5), Feature D (rank 4), Feature A (rank 3), Feature C (rank 2)]. In this example, Feature B and D are strong candidates to be set as common features that can be sent back to the workers in the master ranked list. The selection of the top ranked common features is done based on threshold comparison.

TABLE 1
Ranked Lists of Features Generated By Workers

| Node | Feature | Importance |
|---|---|---|
| Node A | Feature A | 0.22 |
| | Feature B | 0.19 |
| | Feature C | 0.15 |
| | Feature D | 0.15 |
| | Feature H | 0.01 |
| Node B | Feature B | 0.31 |
| | Feature A | 0.23 |
| | Feature D | 0.2 |
| | Feature C | 0.09 |
| Node C | Feature B | 0.2 |
| | Feature D | 0.1 |
| Node D | Feature A | 0.43 |
| | Feature B | 0.17 |
| Node E | Feature B | 0.4 |
| | Feature D | 0.21 |

Once the features are selected, reinforcement learning may be further utilized to minimize the network foot print of the training while maximizing the overall accuracy.

Referring to the flow diagram of FIG. 6C, after feature selection, the master sends back a model configuration 632 including the common features to all workers, and at block 634 the workers train on those common features, computed by master, with different number of layers and hyperparameters. The accuracy 636 with the corresponding details of the model is reported back to the master, which averages the accuracy across all workers (block 638) and updates the model (block 640).

Once the selection of the features match, the updated feature set/model configuration 542 is sent to all workers. All workers explore combinations of the features (input dimension) together with the number of layers and sends back the configuration that maximizes the individual worker accuracy values. The goal is to maximize the mean accuracy from all workers, minimize variance/overfit on each individual worker, and minimize the network footprint of the weights, this is measured with the array size, hence minimize the array size of the weights. This is done by minimizing the input feature size, minimizing the number of layers, and minimizing the number of neurons on each hidden layer. The input feature size may be reduced by controlling the window size in long short-term memory, LSTM, (the lag) and the input features in supervised learning tasks. The constraints are that the feature set is the same and the layers are the same on all computation nodes (i.e., workers).

Reinforcement Learning (RL) uses a reward function such as the following.

Reward=MeanAccuracy/(epsilon+(VarianceAccuracy+Σₗ₌₀^{L}n_{i,l}))

In the above reward function, n_{i,l} is the number of neurons in layer l of worker i. All workers may have the same neural network architecture. Epsilon is a small constant that prevents the denominator from being zero. The higher the number of features, hidden layers, and number of layers, the higher the network size, hence the network foot print, hence the lower the reward. L is the upper boundary for the layer count in the RL exploration phase. The RL agent at the workers aims to maximize the above reward function. Observe that low variance in the worker accuracies increases the overall reward. The RL agent chooses the best combination of the above parameters using trial and error. It should also be noted that there might be more than one optimal solution, hence the episode during the RL training phase should end immediately after a particular goal (a target reward value) has reached, regardless of the chosen parameter combination.

Once the RL phase ends, i.e., the phase that finds the best configuration using RL, the master broadcasts back the configuration parameters to all workers and then the FL training phase starts.

Federated Model Fine Tuning

In a Federated Learning system, the data from multiple workers are used to collaboratively generate a single model at a master. The model that is generated using all the data may generalize quite well. However, the model may not perform as well for individual workers with heterogenous data which has patterns that are different from the other workers. Therefore, it is desirable to fine tune the master model in order to adapt and personalize it for each worker. Personalized models can then be deployed at each worker.

In some embodiments, fine tuning may be performed during and after training. During federated training, at each round, each worker evaluates the model on its local validation data, for example, by calculating a metric, such as an AUC (Area Under the ROC Curve) score, an F1-score, etc. At each round, the worker can choose a strategy for reporting updated model weights that can be characterized as “selfish” or “selfless.” For example, in a “selfish” strategy, if the evaluation results at a current round are worse than the results at any of the previous rounds, the worker may re-use the weights at the round with the best evaluation results and report the weights from that round back to the master. If the local evaluation results do not improve after k rounds, the worker can also decide to leave the federation and use its best local model instead.

Alternatively, in “selfless” strategy, the worker can stay in the federation and send back the latest weights calculated at the current round to the master, while keeping the weights of the best round locally.

The workers can decide which strategy to follow locally. In the same federation, different workers may follow different strategies. The chosen strategy can also dynamically change.

When federated training is finalized, the worker decides locally whether to use the master model which was sent back at final round M or use the weights from any other round which lead to the best local results. Alternatively, the worker can fine tune the weights of all or some of the layers of the master model at last round to generate a personalized model locally.

In another alternative, the worker may use an ensemble of the master and local model, for example, by using a weighted sum of the probability values from each model.

A late-joiner, which does not have enough (labeled) data locally, has to deploy the master/global model. Once enough local data is available, the node can fine tune the model locally.

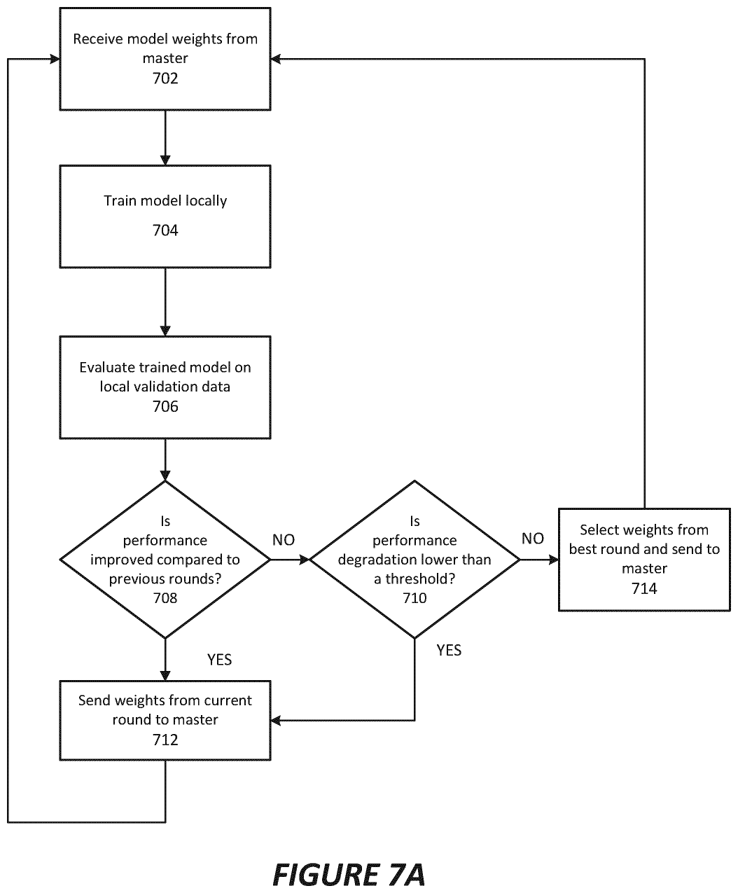

FIGS. 7A and 7B are flowchart of operations for federated model fine tuning according to some embodiments. Referring to FIG. 7A, a method of training a neural network at a worker entity in a federated learning system according to some embodiments includes receiving a set of initial model weights from a master entity (block 702), training the neural network model using the set of initial model weights to obtain a set of modified model weights (block 704), evaluating performance of the model using local data (block 706), determining whether the performance of the model has improved or degraded relative to a previous performance of the model following a previous training round of training neural networks in the federated learning system (708), and in response to determining that the performance of the model has improved relative to the previous performance of the model following the previous training round, transmitting the modified model weights to the master entity for federation by the master entity and selecting the modified model weights for use in operating the neural network (block 712).

Evaluating the performance of the model may include evaluating the performance of the model against local validation data that is local to the worker entity.

The method may further include, in response to determining that the performance of the model has degraded relative to the previous performance of the model following the previous training round, determining whether a level of performance degradation is less than a threshold (block 710), and in response to determining that the level of performance degradation is less than the threshold, transmitting the modified model weights to the master entity for federation by the master entity and selecting the modified model weights for use in operating the neural network (block 712).

The method may further include, in response to determining that the level of performance degradation is greater than the threshold, transmitting a previous set of model weights generated in connection with the previous training round to the master entity for federation by the master entity (block 714), and selecting the previous set of model weights for use in operating the neural network.

The method may further include, in response determining that the level of performance has degraded relative to the previous performance of the model following the previous training round, determining whether or not to participate in future rounds of training neural networks in the federated learning system.

The method may further include receiving a set of final model weights from the master entity, evaluating the performance of the neural network using the final model weights, re-training the neural network starting with the final model weights to obtain modified final model weights, evaluating the performance of the neural network using the modified final model weights, comparing performance of the neural network using the final model weights to performance of the neural network using the modified final neural network weights, and selecting a set of neural network weights from among the final neural network weights and the modified final neural network weights in response to the comparison.

The method may further include comparing performance of the neural network using the final model weights to performance of the neural network using the modified final neural network weights and intermediate sets of neural network weights generated during a federated learning round, and selecting a set of neural network weights from among the final neural network weights, the modified final neural network weights and the intermediate neural network weights in response to the comparison.

The method may further include combining the final neural network weights with the modified final neural network weights and/or one or more sets of intermediate neural network weights to obtain a combined set of neural network weights, and operating the neural network using the combined set of neural network weights.

Combining the first neural network weights with the modified final neural network weights and/or one or more sets of intermediate neural network weights may include generating a weighted average of the first neural network weights and the modified final neural network weights and/or one or more sets of intermediate neural network weights.

Referring to FIG. 7B, a method of training a neural network at a worker entity in a federated learning system according to some embodiments includes receiving final model weights from a master entity (block 752), evaluating a final model performance on local validation data (block 754), re-training the weights of X layers of the neural network on local data, where X is 0 . . . N (block 756) and evaluating model performance with the re-trained weights on local data (block 758). The method compares the results of the final model with the results with the re-trained weights and selects the model with the best performance (block 760), and deploys the best model locally (block 762).

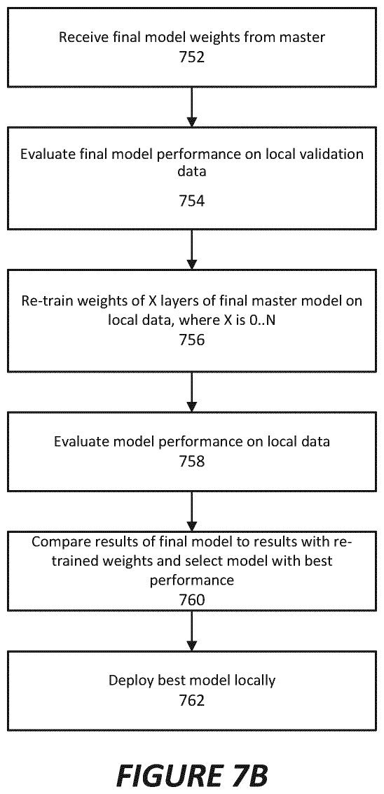

FIG. 8 is a flow diagram illustrating federated model fine tuning according to some embodiments. As shown in FIG. 8, a master 110 provides initial model weights 802 to one or more workers 120. In Round 0, the workers use the initial model weights for local training 804 and send the updated local weights 806 back to the master. The master 110 and worker 120 then engage in multiple rounds of training in which the master 110 generates averaged model weights (block 815) and provides the averaged model weights 808 to each worker 120. Each worker 120 performs local training 810 starting with the averaged model weights and reports the resulting weights 812 to the master 110.

Once the average weights have converged, in a final round (Round M), the master 110 transmits the final model weights 814 to the workers 120. The workers 120 may then perform local fine tuning 816 on the final model weights.

Dynamic Federation Formation

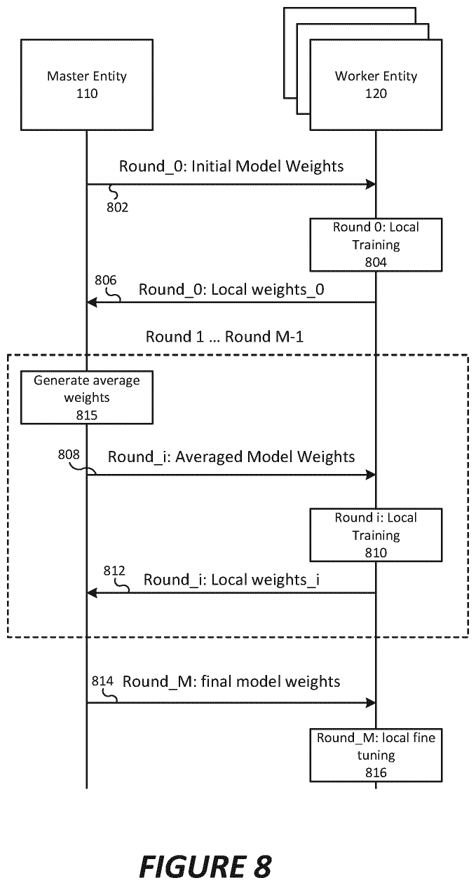

FIG. 9 illustrates topologies for training systems, including various topologies that a Federated Learning system may have. In this context, “topology” refers to the arrangement of the worker and/or master entities. For example, a federated learning system may have a hierarchical topology, such as a master-worker topology in which training at workers is coordinated by the master, a round-robin topology in which workers share weights as peers in a round-robin configuration such that weights are passed to only one other peer, or a butterfly topology in which workers share weights as peers directly to all other workers.

Accordingly, depending on the availability of resources, different topologies can be derived when it comes to training a machine learning model ranging from conventional approaches, such as centralized training, which requires transfer of data to a central data center, to isolated training where training takes place in the same place as the dataset but no learnings are shared, to federated learning where learnings can be shared between the various data stores that collect data. In this context, “learnings” refers to weights generated as part of local training of a machine learning model.

Transfer learning can also be applied in a federated learning system. The idea with transfer learning is to freeze certain layers (typically the first few layers of a neural network) and retrain the remaining layers. This may reduce network footprint since a worker entity only needs to transfer back the part of the network that changed and may also reduce processing power needed, since transfer learning limits the number of layers that are retrained.

Consequently, different training topologies can be constructed. Some embodiments described herein estimate the cost of one or more potential topologies. Some embodiments may dynamically switch from one topology to another if it no longer becomes possible to sustain a particular topology from a cost perspective or due to lack of resources. One strategy would be based on availability. Since multiple topologies are produced, those that fail can be discarded thus giving way to those that can be instantiated.

In this case, “cost” does not refer to monetary cost of each topology but instead refers to the cost of data transfer and required floating point operations needed for each model.

The amount of floating operations per second for a machine learning model can be derived using different mechanisms. For simplicity, an equation is described herein that relates the number of layers of each model with the most expensive operation, which is that of the scalar product. This approach works well for fully connected neural networks that use gradient descent, no regularization, and rectified linear unit (ReLU) as the activation function. This approach is intended to identify a worst-case boundary for the amount of computation needed for inference. The equation is shown below:

2*m*N(l+1)*[Nl+1] flops per layer (where m=number of samples and N(l) layer size)

As an example, available Flops per device are shown below for various systems:

Cloud: Nvidia GTX 1080 TI GPU ˜11 TFLOPS

Edge: Nvidia Jetson TX2 ˜1.5 TFLOPS

Fastest SuperComputer 2016 (Sunway TaihuLight) ˜93 PFLOPS

The network footprint for different types of topologies can be identified using the formulas in Table 2 below:

TABLE 2
Network Footprint Formulas

| | | Downlink | Uplink |
|---|---|---|---|
| | | consumption | consumption |
| Centralized training | Master | ${\sum }_{i = 0}^{N} {n}_{i}$ | N * model0 |
| | Worker i | model0 | nᵢ |
| Isolated | Master | 0 | 0 |
| training | Worker i | 0 | 0 |
| Federated | Master | N * R * model0 | N * R * model0 |
| training | Worker i | R * model0 | R * model0 |
| Round | Worker i | R * model0 | R * model0 |
| Robin | | | |
| Hierarchical | Master | N_FL * R * | N_FL * R * |
| | | model0 | model0 |

i: worker id
N: number of workers
R: number of rounds needed until accuracy convergences
Model0: Size of ML model
ni: size of dataset in worker i
N_FL: federated training cost

Each topology can be represented as an adjacency list. Table 3 illustrates an example of an adjacency list representing the topology for centralized training, where ‘1’ indicates an edge between the different nodes while a ‘0’ indicates that there is no edge.

TABLE 3
Adjacency List

| | 0 | 1 | 2 | 3 | 4 | 5 | 6 | 7 | 8 |
|---|---|---|---|---|---|---|---|---|---|
| 0 | 0 | 1 | 1 | 1 | 1 | 1 | 1 | 1 | 1 |

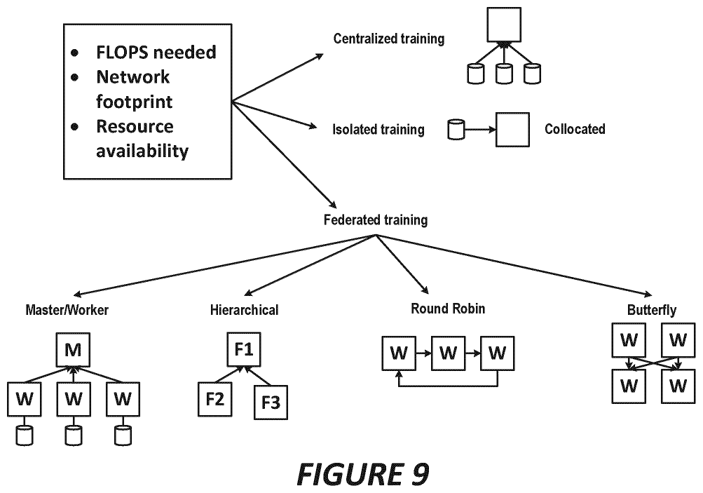

In graph form this table can be visualized as shown in FIG. 10A.

Even though this topology is straightforward in the case of centralized, isolated and typical federated learning it comes with different costs. For centralized the cost is 80 (8 workers, 10 MB of data), for isolated the cost is 0 (no data transfer) for federated the cost is 40 (assuming 5 rounds, if there are 10 rounds it would be, or 80 as much as centralized training). For hierarchical training the question to answer is how many masters the training should include. If two masters are added, the topology is shown in the graph shown in FIG. 10B.

With this approach the cost increases slightly (from 40 to 60 since two new masters are added that perform two additional federations of cost 10). However, at the same time the amount of information that is sent on node 0 is decreased, the cost is still smaller than centralized and the system has a more fault-tolerant setup since the system can still federate even if 2′ federation fails.

Given the boundaries provided by the previous formulas, different strategies can be employed ranging from greedy search to dynamic programming in order to generate different topologies. Following is an example that relies on breadth first search (BF S) traversal to group possible federations:
federations={ }
visited=[ ]
queue=[start] # start indicates the root node
while len(queue) !=0:
   vertex=queue.pop( )
   if vertex not in visited:
      visited.append(vertex)
      level=distance(start, vertex)
      nodes_in_federation=federations.get(level)
      nodes_in_federation.append(vertex)
      federations[level]=nodes_in_federation
      for node in graph.get(vertex, [ ]):
         queue.append(node)
return federations

Once this algorithm is complete, the system can perform a computation to determine the amount of computing resources required along with the network footprint in order to determine if a particular topology can sustain the proposed set of masters or not. In some embodiments, the system could check in every iteration and pre-cache previous results in case a similar case has been addressed before.

FIG. 10C illustrates a process for switching between topologies. The process is triggered by way of CICD (Continuous Integration Continuous Deployment). This may be performed via automation (e.g., by a script that runs periodically), which submits the model architecture, including the layers of neural network, the activation functions, etc., to the Topology Manager. In addition to the Topology Manager, the system includes a Topology Generator and a Topology Converter. In addition, a version control module may be included. A selected topology may be implemented, for example, using a Kubernetes API (kube API).

In step 2), the Topology Manager generates all possible topologies for the proposed model architecture using the help of the Topology Generator and the Topology Converter. In particular, the Topology Manager sends a create_topologies command to the Topology Generator including the model architecture (model_arch) as a parameter.

In step 3), the topology generator produces a set of tuples [(c0,t0,t1), (c2,t3,t4) . . . (cn,tn)] grouped by cost for different topologies for the input model architecture, and returns the tuples to the Topology Manager. This includes centralized, isolated and federated topologies. An example topology (t0) is shown in Table 4 below.

TABLE 4
Example Topology

T0 (Topology 0)
masters: 1
workers: 1
image: nsc-registry.infra.ericsson.se:5000/ms_algo/erday19/nflp:v1
common-config: common-config

In step 4), the topology is converted into a manifest, which provides instructions for implementing the topology. An example of a manifest with one master and one worker is shown in Table 5, below.

TABLE 5
Example Manifest

```
kind: Deployment
spec:
  template:
  spec:
      containers:
      -command: [“/root/start_stateless_agent.sh”, “master-2”]
        image: nsc-registry.infra.ericsson.se:5000/ms_algo/erday19/nflp:v1
        envFrom:
        - configMapRef:
            name: common-config
        imagePullPolicy: Always
        name: master-2
        resources:
          requests:
            cpu: ‘1’
            memory: 1Gi
          limits:
            cpu: ‘1’
            memory: 1Gi
        volumeMounts:
        - name: config-volume
          mountPath: /root/graphs
      volumes:
      - name: config-volume
        configMap:
            name: graphs-config
    metadata:
      labels:
        app: master-2
  replicas: 1
apiVersion: extensions/v1beta1
metadata:
  name: master-2
kind: Deployment
spec:
  template:
    spec:
      containers:
      - command: [“/root/start_stateless_agent.sh”, “worker-13”]
        image: nsc-registry.infra.ericsson.se:5000/ms_algo/erday19/nflp:v1
        envFrom:
        - configMapRef:
            name: common-config
        imagePullPolicy: Always
        name: worker-1
        resources:
          requests:
            cpu: ‘1’
            memory: 1Gi
          limits:
            cpu: ‘1’
            memory: 1Gi
        volumeMounts:
        - name: config-volume
          mountPath: /root/graphs
      volumes:
      - name: config-volume
        configMap:
          name: graphs-config
    metadata:
      labels:
        app: worker-1
  replicas: 1
apiVersion: extensions/v1beta1
metadata:
  name: worker-1
```

This format is meant to be specific to the underlying infrastructure that will implement the topology. In this example, the underlying infrastructure is a kubernetes cluster (kube API).

In step 6), the newly created manifest is committed back to the version control system associated with the CICD process.

In step 7), the CICD rolls out the new topology to the control plane of the kubernetes cluster. The kubernetes cluster reconfigures its nodes based on their availability to support the new topology.

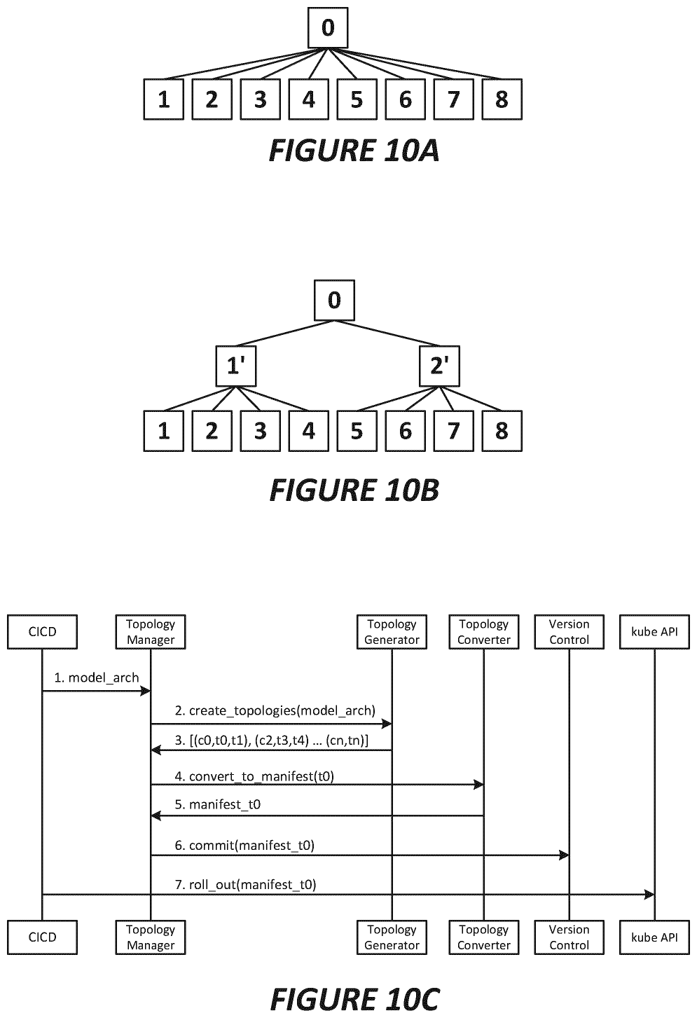

The sequence diagram shown in FIG. 11 describes an exemplary embodiment for the generation of different topologies.

In the example shown in FIG. 11, a topology generator node sends a pull query 1102 to a repository, which provides a neural network architecture 1104. The topology generator generates (1106) one or more possible topologies that could be implemented and sends the topologies 1108 to a topology verification node. The topology verification node ranks the topologies 1110 and sends the ranked topologies 1112 to a topology handler. In an offline phase, the topology verification node identifies the network footprint and needed flops. In an online phase, the topology handler identifies in real time whether the expected resources, as grouped under different infrastructure controllers, can instantiate the expected topology or not. In particular, the topology handler identifies capability of one or more infrastructure controllers to implement each of the ranked topologies. For each topology that can be implemented, the topology handler deploys the topology 1115 to an Infrastructure-as-a-service (IaaS) node. and receives state information 1116 in response. The IaaS node instantiates the topology (block 1118) and optionally starts a master node FL-M (1120). The FL-M may commit the trained model 1122 to the repository.

Conservatively, the method picks the top-k topologies and then checks which one can be instantiated. For simplicity this sequence diagram produces an FL based topology (FL_M), however, in the same fashion other topologies can be instantiated.

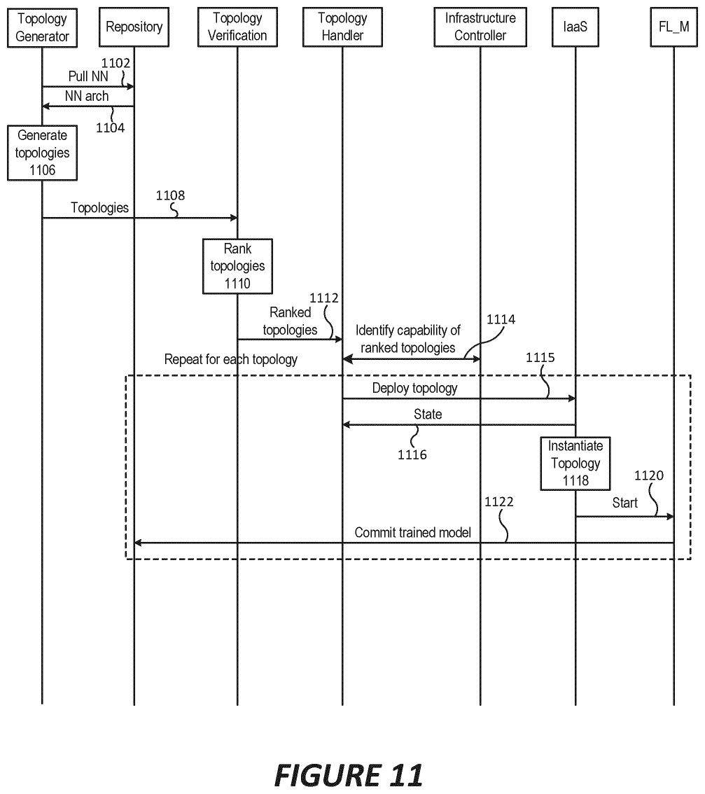

FIG. 12 illustrates a method of generating a federated learning topology including a plurality of worker entities for training a neural network according to some embodiments. The method includes generating a plurality of different topologies for a federated learning system, wherein the federated learning system includes the plurality of worker entities (block 1202) and, for each of the plurality of topologies, estimating a cost of operating the federated learning system using the topology (block 1204). The method then selects a subset of the topologies based on the estimated cost (block 1206) and determines whether the topologies in the selected subset of topologies can be instantiated (block 1208). The method then selects a topology for implementation based on the determination of whether the topologies in the selected subset of topologies can be instantiated (block 1210).

Estimating the cost of operating the federated learning system using a selected topology may include estimating a cost of data transfer associated with the selected topology.

Estimating the cost of operating the federated learning system using a selected topology may include estimating a number of floating point operations per second, FLOPS, associated with the selected topology.

Estimating the number of floating point operations per second associated with the selected topology may include estimating, for a layer in the neural network, a number of FLOPS needed based on a scalar product operation on the layer.

Estimating the number of FLOPS associated with the selected topology may include estimating the number of FLOPS according to the following formula for a layer in the neural network:

2*m*N(l+1)*[Nl+1] FLOPS per layer

where m is a number of samples in a data set processed by the neural network and N(l) is a layer size of the neural network.

The method may further include, for each selected topology, generating a network footprint associated with the topology; and estimating an availability of resources needed to implement the network footprint associated with the topology.

The topology may include one of a centralized training topology, an isolated training topology, a federated training topology, a round robin topology and a hierarchical topology.

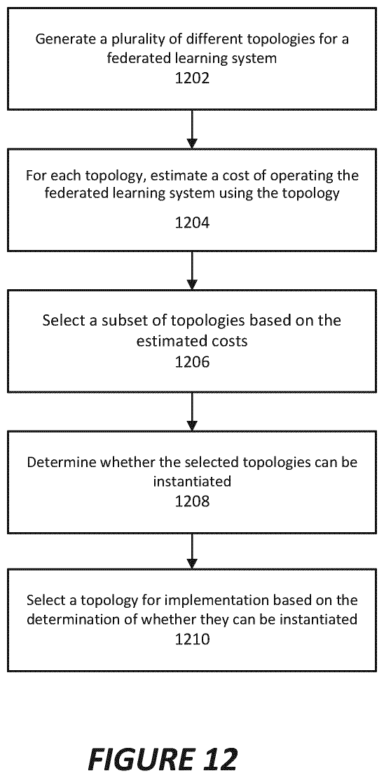

FIG. 13 is a block diagram illustrating elements of a federated learning entity 900 (or “FL entity”). A FL entity 900 may implement a node or entity in a federated learning environment, including a worker node and/or a master node as the context requires. A FL entity 900 can take the form of and be referred to as a terminal, a communication terminal, mobile terminal, a mobile communication terminal, a wired or wireless communication device, a wireless terminal, a wireless communication terminal, a network device, a network node, a desktop device, a laptop, a base station, a server, eNodeB/eNB, gNodeB/gNB, a worker node/terminal/device, etc.).

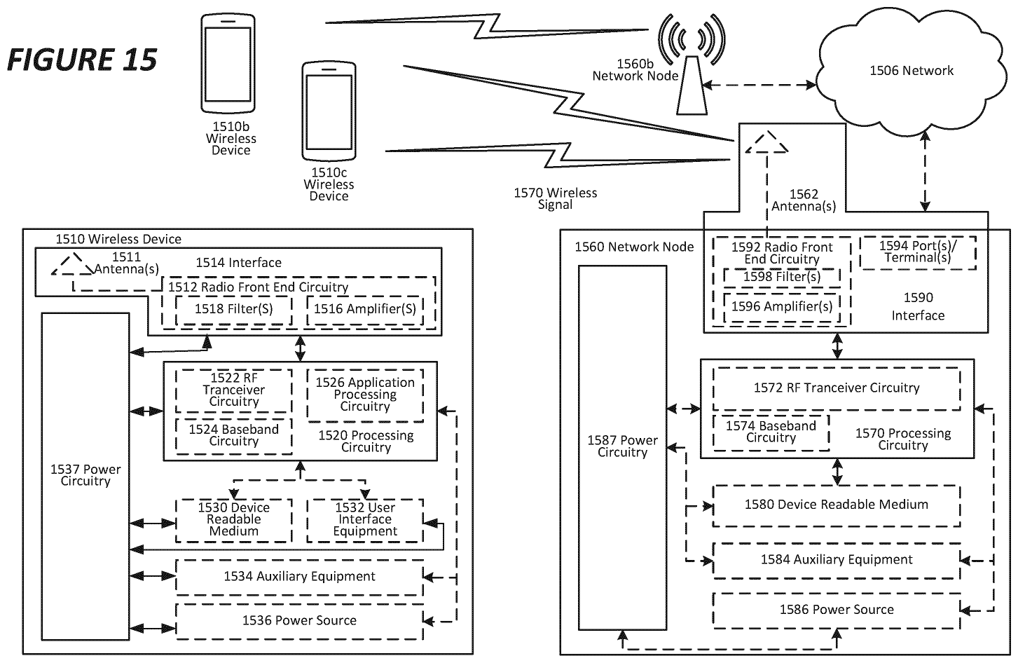

A FL entity 900 may be configured to provide communications according to embodiments of inventive concepts. (FL entity 900 may be provided, for example, as discussed below with respect to wireless device 1510 or network node 1560 of FIG. 15 when in a wireless telecommunications environment.) As shown, FL entity 900 may include transceiver circuitry 901 (also referred to as a transceiver, e.g., corresponding to interface 1514 or RF transceiver circuitry 1572 when in a wireless telecommunications environment of FIG. 15) including a transmitter and a receiver configured to provide uplink and downlink radio communications or wired communications with a network node. FL entity 900 may also include processing circuitry 903 (also referred to as a processor, e.g., corresponding to processing circuitry 1520 or processing circuitry 1570 of FIG. 15 when used in a telecommunications environment) coupled to the transceiver circuitry, and memory circuitry 905 coupled to the processing circuitry. The memory circuitry 905 may include computer readable program code that when executed by the processing circuitry 903 causes the processing circuitry to perform operations according to embodiments disclosed herein. According to other embodiments, processing circuitry 903 may be defined to include memory so that separate memory circuitry is not required. FL entity 900 may also include an interface (such as a user interface) 907 coupled with processing circuitry 903, and/or worker node may be incorporated in a vehicle.

As discussed herein, operations of a FL entity 900 may be performed by processing circuitry 903 and/or transceiver circuitry 901 and/or network interface 907. For example, processing circuitry 903 may control transceiver circuitry 901 to transmit communications through transceiver circuitry 901 over a radio interface to a master node and/or to receive communications through transceiver circuitry 901 from a master node and/or another worker node over a radio interface. Processing circuitry 903 may control network interface circuitry 907 to transmit communications through a wired interface to a master node and/or to receive communications from a master node and/or another worker node over the wired interface. Moreover, modules may be stored in memory circuitry 905, and these modules may provide instructions so that when instructions of a module are executed by processing circuitry 903, processing circuitry 903 performs respective operations discussed below with respect to embodiments relating to FL entity 900). In the description that follows, FL entity 900 may be referred to as a worker, a worker device, a worker node, a master or master device.

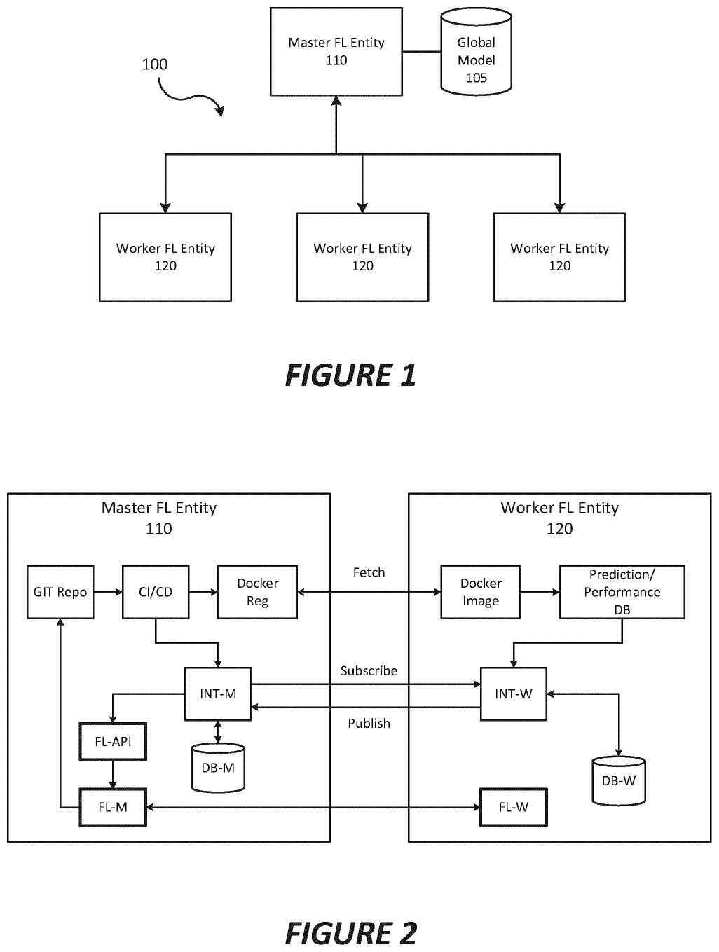

In particular embodiments, an FL entity 900 or group of FL entities 900 may be configured to perform operations as described in connection with FIGS. 1 to 8.

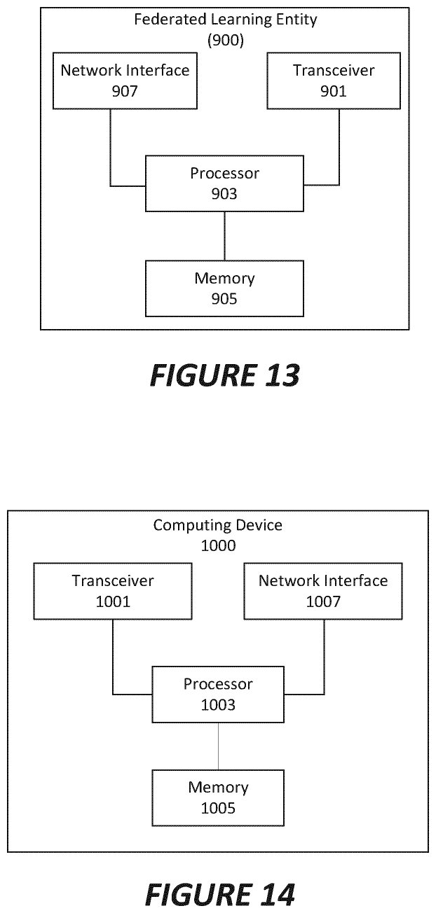

FIG. 14 is a block diagram illustrating elements of a computing device 1000, which may take the form of and be referred to as a terminal, a communication terminal, mobile terminal, a mobile communication terminal, a wired or wireless communication device, a wireless terminal, a wireless communication terminal, a desktop device, a laptop, a network node, a base station, a server, eNodeB/eNB, gNodeB/gNB, a master node/terminal/device, a leader node/terminal/device, etc.) configured to provide cellular communication or wired communication according to embodiments of inventive concepts. (Computing device 1000 may be provided, for example, as discussed below with respect to network node 1560 or wireless device 1510 of FIG. 15 when used in a telecommunications network.) As shown, the master node may include transceiver circuitry 1001 (also referred to as a transceiver, e.g., corresponding to portions of interface 1590 or interface 1514 of FIG. 15 when used in a telecommunications network) including a transmitter and a receiver configured to provide uplink and downlink radio communications with mobile terminals. The computing device 1000 may include network interface circuitry 1007 (also referred to as a network interface, e.g., corresponding to portions of interface 1590 or interface 1514 of FIG. 15 when used in a telecommunications network) configured to provide communications with other nodes (e.g., with other master nodes and/or worker nodes). The computing device 1000 may also include a processing circuitry 1003 (also referred to as a processor, e.g., corresponding to processing circuitry 1570 or processing circuitry 1520 of FIG. 15 when used in a telecommunications network) coupled to the transceiver circuitry and network interface circuitry, and a memory circuitry 1005 (also referred to as memory, e.g., corresponding to device readable medium 1580 or 1530 of FIG. 15) coupled to the processing circuitry. The memory circuitry 1005 may include computer readable program code that when executed by the processing circuitry 1003 causes the processing circuitry to perform operations according to embodiments disclosed herein. According to other embodiments, processing circuitry 1003 may be defined to include memory so that a separate memory circuitry is not required.

As discussed herein, operations of the computing device 1000 may be performed by processing circuitry 1003, network interface 1007, and/or transceiver 1001. For example, processing circuitry 1003 may control transceiver 1001 to transmit downlink communications through transceiver 1001 over a radio interface to one or more worker nodes and/or to receive uplink communications through transceiver 1001 from one or more worker nodes over a radio interface. Similarly, processing circuitry 1003 may control network interface 1007 to transmit communications through network interface 1007 to one or more other master nodes and/or to receive communications through network interface from one or more other network nodes and/or devices. Moreover, modules may be stored in memory 1005, and these modules may provide instructions so that when instructions of a module are executed by processing circuitry 1003, processing circuitry 1003 performs respective operations (e.g., operations discussed below with respect to embodiments relating to master nodes).

In particular embodiments, a computing device 1000 or group of computing devices 1000 may be configured to perform operations as described in connection with FIGS. 9 to 12.

### EXAMPLE EMBODIMENTS

Federated Feature Selection

Embodiment 1. A method of performing federated feature selection for a machine learning model in a federated learning environment, the method comprising:
at a first resolution, obtaining (502) a global set of selector neural network weights;
at a second resolution, for each of a plurality of first data subsets of a data set of data samples extracted from a system to be modeled, wherein the data samples are associated with features in a feature space of the system, selecting (504) a first set of features from the feature space by iteratively applying a first selector neural network that is initialized with the global set of selector neural network weights to the first data subset to obtain a first set of selector neural network weights;
dividing (506) each of the first data subsets into a plurality of second data subsets; and
at a third resolution, for each of the plurality of second data subsets, selecting (508) a second set of features from the feature space, wherein, for each of the plurality of second data subsets, selecting the second set of features comprises iteratively applying a second selector neural network that is initialized with the first set of selector neural network weights to the second data subset to obtain a second set of selector neural network weights.

Embodiment 2. The method of Embodiment 1, further comprising: providing selector neural network weights from a highest resolution to the first resolution.

Embodiment 3. The method of Embodiment 2, wherein obtaining the global set of weights comprises, at the first resolution, averaging the selector neural network weights provided by the selector neural networks at the highest resolution.

Embodiment 4. The method of Embodiment 1, wherein selecting the set of features comprises applying the selector neural network to the data set of data samples using a preliminary set of neural network weights to obtain a preliminary set of features, generating a reconstructed set of data samples from the preliminary set of features using a decoder neural network, generating a loss metric based on a difference between the set of original data samples and the set of reconstructed data samples and updating the preliminary set of neural network weights to obtain an updated set of neural network weights based on the loss metric.

Embodiment 5. The method of Embodiment 4, wherein the steps of applying the selector network to the data set of data samples, generating the reconstructed set of data samples, generating the loss metric and updating the preliminary set of neural network weights are repeated until the updated set of neural network weights converges.

Embodiment 6. The method of any of Embodiments 1 to 5, wherein the federated learning environment includes a master entity and a plurality of worker entities.

Embodiment 7. The method of Embodiment 6, wherein obtaining the global set of selector neural network weights is performed by the master entity.

Embodiment 8. The method of Embodiment 7, wherein selecting the first set of features from the feature space at the second resolution is performed by the worker entities given the global weights from the master entity.

Embodiment 9. The method of any of Embodiments 1 to 8, wherein dividing the data set into the plurality of first data sets is performed in a random fashion.

Embodiment 10. The method of any of Embodiments 1 to 8, wherein dividing the data set into the plurality of first data sets is performed in a determinative fashion.

Embodiment 11. The method of Embodiment 10, wherein dividing the data set into the plurality of first data sets comprises dividing the data set into operator-specific sub sets.

Embodiment 12. The method of any of Embodiments 1 to 11, further comprising:
averaging the second sets of selector neural network weights to obtain an averaged set of selector neural network weights; and
repeating operations of selecting a set of features from the feature space by iteratively applying the first selector neural network to the data set starting with the averaged set of selector neural network weights.

Embodiment 13. A federated learning entity (900), comprising:
a processing circuit (903); and
a memory (905) coupled to the processing circuit and comprising computer readable program instructions that, when executed by the processing circuit, cause the federated learning entity to perform operations of:
at a first resolution, obtaining (502) a global set of selector neural network weights;
at a second resolution, for each of a plurality of first data subsets of a data set of data samples extracted from a system to be modeled, wherein the data samples are associated with features in a feature space of the system, selecting (504) a first set of features from the feature space by iteratively applying a first selector neural network that is initialized with the global set of selector neural network weights to the first data subset to obtain a first set of selector neural network weights;
dividing (506) each of the first data subsets into a plurality of second data subsets; and
at a third resolution, for each of the plurality of second data subsets, selecting (508) a second set of features from the feature space, wherein, for each of the plurality of second data subsets, selecting the second set of features comprises iteratively applying a second selector neural network that is initialized with the first set of selector neural network weights to the second data subset to obtain a second set of selector neural network weights.

Embodiment 14. The method of Embodiment 13, wherein the federated learning entity is configured to perform operations according to any of Embodiments 2 to 12.

Embodiment 15. A federated learning entity (900) that is configured to:
at a first resolution, obtaining (502) a global set of selector neural network weights;
at a second resolution, for each of a plurality of first data subsets of a data set of data samples extracted from a system to be modeled, wherein the data samples are associated with features in a feature space of the system, selecting (504) a first set of features from the feature space by iteratively applying a first selector neural network that is initialized with the global set of selector neural network weights to the first data subset to obtain a first set of selector neural network weights;
dividing (506) each of the first data subsets into a plurality of second data subsets; and
at a third resolution, for each of the plurality of second data subsets, selecting (508) a second set of features from the feature space, wherein, for each of the plurality of second data subsets, selecting the second set of features comprises iteratively applying a second selector neural network that is initialized with the first set of selector neural network weights to the second data subset to obtain a second set of selector neural network weights.

Ranking-Based Feature Selection

Embodiment 16. A method of performing feature selection in a federated learning system, comprising:
receiving (602), at a master entity, from each of a plurality of worker entities, a ranked list of features based on a subset of data samples associated with the worker entity;
at the master entity, ranking (604) the features based on the ranked lists to obtain a master ranked list of features; and
transmitting (606) the master ranked list of features to the plurality of worker entities for training a respective neural network using their respective subset of data samples.

Embodiment 17. The method of Embodiment 16, wherein the features are selected from a feature space of a system to be modeled.

Embodiment 18. The method of Embodiment 16 or 17, wherein ranking the features comprises identifying features that are common to the ranked lists.

Embodiment 19. The method of any of Embodiments 16 to 18, wherein generating the ranked list of features comprises applying a random forest procedure to the features.

Embodiment 20. The method of any of Embodiments 16 to 19, wherein ranking the features is performed based on frequency of appearance and/or ranking of the features in the ranked lists.

Embodiment 21. The method of any of Embodiments 16 to 20, further comprising:
receiving, from each of the plurality of worker entities, an accuracy value that measures accuracy of the neural network trained using the master ranked list of features;
receiving, from each of the plurality of worker entities, a model configuration that comprises a number of model layers and a set of features of the neural network trained using the master ranked list of features;
generating an updated master ranked list of features using Reinforcement Learning based on model configurations and accuracies; and
transmitting the updated master ranked list of features to each of the plurality of worker entities.

Embodiment 22. A federated learning entity (900), comprising:
a processing circuit (903); and
a memory (905) coupled to the processing circuit and comprising computer readable program instructions that, when executed by the processing circuit, cause the federated learning entity to perform operations of:
receiving (602), at a master entity, from each of a plurality of worker entities, a ranked list of features based on a subset of data samples associated with the worker entity;
at the master entity, ranking (604) the features based on the ranked lists to obtain a master ranked list of features; and
transmitting (606) the master ranked list of features to the plurality of worker entities for training a respective neural network using their respective subset of data samples.

Embodiment 23. The federated learning entity of Embodiment 22, wherein the federated learning entity is configured to perform operations according to any of claims 17 to 21.

Embodiment 24. A federated learning entity (900), configured to:
receive (602), at a master entity, from each of a plurality of worker entities, a ranked list of features based on a subset of data samples associated with the worker entity;
at the master entity, rank (604) the features based on the ranked lists to obtain a master ranked list of features; and
transmit (606) the master ranked list of features to the plurality of worker entities for training a respective neural network using their respective subset of data samples.

Embodiment 25. A method of performing feature selection in a federated learning system, comprising:
selecting (622), at a worker entity, a first set of features from a feature space of a system to be modeled;
generating (624) a ranked list of the selected features based on a subset of data samples associated with the worker entity;
transmitting (626) the ranked list of features to a master entity;
receiving (628) a master ranked list of features from the master entity; and
training (630) a neural network using the subset of data samples and the master ranked list of features.

Embodiment 26. The method of Embodiment 25, further comprising:
calculating an accuracy of the neural network training; and
transmitting the accuracy to the master entity.

Embodiment 27. The method of Embodiment 25 or 26, further comprising:
generating a model configuration comprising a number of model layers and a set of features; and
transmitting the model configuration to the master entity.

Embodiment 28. The method of any of Embodiments 25 to 27, wherein a reinforcement learning agent generates a model configuration that maximizes mean worker accuracy, minimizes variance of worker accuracy, minimizes neural network size, and minimizes feature size.

Embodiment 29. The method of any of Embodiments 25 to 28, further comprising:
evaluating the accuracy of the neural network training using reinforcement learning with the following reward formula:

Reward=MeanAccuracy/(epsilon+(VarianceAccuracy+Σᵢ₌₀^{L}n_{i,l}))
where n_{i,l} is a number of neurons in layer l of worker i, epsilon is a small value, MeanAccuracy is the mean accuracy of the neural network, VarianceAccuracy is the accuracy variance of the neural network, and L is an upper boundary for the layer count in a reinforcement learning exploration phase.

Embodiment 30. A federated learning entity (900), comprising:
a processing circuit (903); and
a memory (905) coupled to the processing circuit and comprising computer readable program instructions that, when executed by the processing circuit, cause the federated learning entity to perform operations of:
selecting (622), at a worker entity, a first set of features from a feature space of a system to be modeled;
generating (624) a ranked list of the selected features based on a subset of data samples associated with the worker entity;
transmitting (626) the ranked list of features to a master entity;
receiving (628) a master ranked list of features from the master entity; and
training (630) a neural network using the subset of data samples and the master ranked list of features.

Embodiment 31. The federated learning entity of Embodiment 30, further configured to perform operations according to any of Embodiments 26 to 29.

Embodiment 32. A federated learning entity (900), configured to:
select (622), at a worker entity, a first set of features from a feature space of a system to be modeled;
generate (624) a ranked list of the selected features based on a subset of data samples associated with the worker entity;
transmit (626) the ranked list of features to a master entity;
receive (628) a master ranked list of features from the master entity; and
train (630) a neural network using the subset of data samples and the master ranked list of features.

Federated Model Tuning

Embodiment 33. A method of training a neural network at a worker entity in a federated learning system, the method comprising:
receiving (702) a set of model weights from a master entity;
training (704) the neural network model using the set of model weights to obtain a set of modified model weights;
evaluating (706) performance of the model;
determining (708) whether the performance of the model has improved or degraded relative to a previous performance of the model following a previous training round of training neural networks in the federated learning system; and
in response to determining that the performance of the model has improved relative to the previous performance of the model following the previous training rounds, transmitting (712) the modified model weights to the master entity for federation by the master entity and selecting the modified model weights for use in operating the neural network.

Embodiment 34. The method of Embodiment 33, wherein evaluating the performance of the model comprises evaluating the performance of the model against local validation data that is local to the worker entity.

Embodiment 35. The method of Embodiment 33 or 34, further comprising:
in response to determining that the performance of the model has degraded relative to the previous performance of the model following the previous training round, determining (710) whether a level of performance degradation is less than a threshold; and
in response to determining that the level of performance degradation is less than the threshold, transmitting (712) the modified model weights to the master entity for federation by the master entity and selecting the modified model weights for use in operating the neural network.

Embodiment 36. The method of Embodiment 35, further comprising:
in response to determining that the level of performance degradation is greater than the threshold, transmitting (714) a previous set of model weights generated in connection with the previous training round to the master entity for federation by the master entity, and selecting the previous set of model weights for use in operating the neural network.

Embodiment 37. The method of any of Embodiments 33 to 36, further comprising, in response determining that the level of performance has degraded relative to the previous performance of the model following the previous training round, determining whether or not to participate in future rounds of training neural networks in the federated learning system.

Embodiment 38. The method of any of Embodiments 33 to 37, further comprising:
receiving a set of final model weights from the master entity;
evaluating the performance of the neural network using the final model weights;
re-training the neural network starting with the final model weights to obtain modified final model weights;
evaluating the performance of the neural network using the modified final model weights;
comparing performance of the neural network using the final model weights to performance of the neural network using the modified final neural network weights; and
selecting a set of neural network weights from among the final neural network weights and the modified final neural network weights in response to the comparison.

Embodiment 39. The method of any of Embodiments 33 to 37, further comprising:
comparing performance of the neural network using the final model weights to performance of the neural network using the modified final neural network weights and intermediate sets of neural network weights generated during a federated learning round; and
selecting a set of neural network weights from among the final neural network weights, the modified final neural network weights and the intermediate neural network weights in response to the comparison.

Embodiment 40. The method of any of Embodiments 33 to 39, further comprising:
combining the final neural network weights with the modified final neural network weights and/or one or more sets of intermediate neural network weights to obtain a combined set of neural network weights; and
operating the neural network using the combined set of neural network weights.

Embodiment 41. The method of Embodiment 40, wherein combining the first neural network weights with the modified final neural network weights and/or one or more sets of intermediate neural network weights comprises generating a weighted average of the first neural network weights and the modified final neural network weights and/or one or more sets of intermediate neural network weights.

Embodiment 42. A federated learning entity (900), comprising: a processing circuit (903); and a memory (905) coupled to the processing circuit and comprising computer readable program instructions that, when executed by the processing circuit, cause the federated learning entity to perform operations of:
receiving (702) a set of model weights from a master entity;
training (704) the neural network model using the set of model weights to obtain a set of modified model weights;
evaluating (706) performance of the model;
determining (708) whether the performance of the model has improved or degraded relative to a previous performance of the model following a previous training round of training neural networks in the federated learning system; and
in response to determining that the performance of the model has improved relative to the previous performance of the model following the previous training rounds, transmitting (712) the modified model weights to the master entity for federation by the master entity and selecting the modified model weights for use in operating the neural network.

Embodiment 43. The federated learning entity of Embodiment 42, further configured to perform operations according to any of Embodiments 33 to 41.

Embodiment 44. A federated learning entity (900), configured to:
receive (702) a set of model weights from a master entity;
train (704) the neural network model using the set of model weights to obtain a set of modified model weights;
evaluate (706) performance of the model;
determine (708) whether the performance of the model has improved or degraded relative to a previous performance of the model following a previous training round of training neural networks in the federated learning system; and
in response to determining that the performance of the model has improved relative to the previous performance of the model following the previous training rounds, transmit (712) the modified model weights to the master entity for federation by the master entity and selecting the modified model weights for use in operating the neural network.

Dynamic Federation Formation

Embodiment 45. A method of generating a federated learning topology including a plurality of worker entities for training a neural network, the method comprising:
generating (1202) a plurality of different topologies for a federated learning system, wherein the federated learning system includes the plurality of worker entities;
for each of the plurality of topologies, estimating (1204) a cost of operating the federated learning system using the topology;
selecting (1206) a subset of the topologies based on the estimated cost;
determining (1208) whether the topologies in the selected subset of topologies can be instantiated; and
selecting (1210) a topology for implementation based on the determination of whether the topologies in the selected subset of topologies can be instantiated.

Embodiment 46. The method of Embodiment 45, wherein estimating the cost of operating the federated learning system using a selected topology comprises estimating a cost of data transfer associated with the selected topology.

Embodiment 47. The method of Embodiment 45 or 46, wherein estimating the cost of operating the federated learning system using a selected topology comprises estimating a computer performance metric associated with the selected topology.

Embodiment 48. The method of Embodiment 47, wherein estimating the computer performance metric comprises estimating, for a layer in the neural network, a number of floating point operations per second, FLOPS, needed based on a scalar product operation on the layer.

Embodiment 49. The method of Embodiment 48, wherein estimating the number of FLOPS associated with the selected topology comprises estimating the number of FLOPS according to the following formula for a layer in the neural network:

2*m*N(l+1)*[Nl+1] FLOPS per layer
where m is a number of samples in a data set processed by the neural network and N(l) is a layer size of the neural network.

Embodiment 50. The method of any of Embodiments 45 to 49, further comprising:
for each selected topology, generating a network footprint associated with the topology; and
estimating an availability of resources needed to implement the network footprint associated with the topology.

Embodiment 51. The method of any of Embodiments 47 to 49, further comprising:
estimating an availability of resources needed to obtain the computer performance metric associated with the selected topology.

Embodiment 52. The method of any of Embodiments 45 to 51, wherein the topology comprises one of a centralized training topology, an isolated training topology, a federated training topology, a round robin topology and a hierarchical topology.

Embodiment 53. A computing device (1000), comprising:
a processing circuit (1003); and
a memory (1005) coupled to the processing circuit and comprising computer readable program instructions that, when executed by the processing circuit, cause the computing device to perform operations of:
generating (1202) a plurality of different topologies for a federated learning system, wherein the federated learning system includes the plurality of worker entities;
for each of the plurality of topologies, estimating (1204) a cost of operating the federated learning system using the topology;
selecting (1206) a subset of the topologies based on the estimated cost;
determining (1208) whether the topologies in the selected subset of topologies can be instantiated; and
selecting (1210) a topology for implementation based on the determination of whether the topologies in the selected subset of topologies can be instantiated.

Embodiment 54. The computing device of Embodiment 53, further configured to perform operations according to any of Embodiments 45 to 52.

Embodiment 55. A computing device (1000) configured to:
generate (1202) a plurality of different topologies for a federated learning system, wherein the federated learning system includes the plurality of worker entities;
for each of the plurality of topologies, estimate (1204) a cost of operating the federated learning system using the topology;
select (1206) a subset of the topologies based on the estimated cost;
determine (1208) whether the topologies in the selected subset of topologies can be instantiated; and
select (1210) a topology for implementation based on the determination of whether the topologies in the selected subset of topologies can be instantiated.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 15 illustrates a wireless network in accordance with some embodiments where the inventive concepts described above may be used.

Although the subject matter described herein may be implemented in any appropriate type of system using any suitable components, the embodiments disclosed herein are described in relation to a wireless network, such as the example wireless network illustrated in FIG. 15. For simplicity, the wireless network of FIG. 15 only depicts network 1506, network nodes 1560 and 1560b, and WDs 1510, 1510b, and 1510c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 1560 and wireless device (WD) 1510 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1560 and WD 1510 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 15, network node 1560 includes processing circuitry 1570, device readable medium 1580, interface 1590, auxiliary equipment 1584, power source 1586, power circuitry 1587, and antenna 1562. Although network node 1560 illustrated in the example wireless network of FIG. 15 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1560 are depicted as single boxes located within a larger box, or nested within multiple boxes, in practice, a network node may comprise multiple different physical components that make up a single illustrated component (e.g., device readable medium 1580 may comprise multiple separate hard drives as well as multiple RAM modules).

Similarly, network node 1560 may be composed of multiple physically separate components (e.g., a NodeB component and a RNC component, or a BTS component and a BSC component, etc.), which may each have their own respective components. In certain scenarios in which network node 1560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1560 may be configured to support multiple radio access technologies (RATs). In such embodiments, some components may be duplicated (e.g., separate device readable medium 1580 for the different RATs) and some components may be reused (e.g., the same antenna 1562 may be shared by the RATs). Network node 1560 may also include multiple sets of the various illustrated components for different wireless technologies integrated into network node 1560, such as, for example, GSM, WCDMA, LTE, NR, WiFi, or Bluetooth wireless technologies. These wireless technologies may be integrated into the same or different chip or set of chips and other components within network node 1560.

Processing circuitry 1570 is configured to perform any determining, calculating, or similar operations (e.g., certain obtaining operations) described herein as being provided by a network node. These operations performed by processing circuitry 1570 may include processing information obtained by processing circuitry 1570 by, for example, converting the obtained information into other information, comparing the obtained information or converted information to information stored in the network node, and/or performing one or more operations based on the obtained information or converted information, and as a result of said processing making a determination.

Processing circuitry 1570 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1560 components, such as device readable medium 1580, network node 1560 functionality. For example, processing circuitry 1570 may execute instructions stored in device readable medium 1580 or in memory within processing circuitry 1570. Such functionality may include providing any of the various wireless features, functions, or benefits discussed herein. In some embodiments, processing circuitry 1570 may include a system on a chip (SOC).

In some embodiments, processing circuitry 1570 may include one or more of radio frequency (RF) transceiver circuitry 1572 and baseband processing circuitry 1574. In some embodiments, radio frequency (RF) transceiver circuitry 1572 and baseband processing circuitry 1574 may be on separate chips (or sets of chips), boards, or units, such as radio units and digital units. In alternative embodiments, part or all of RF transceiver circuitry 1572 and baseband processing circuitry 1574 may be on the same chip or set of chips, boards, or units

In certain embodiments, some or all of the functionality described herein as being provided by a network node, base station, eNB or other such network device may be performed by processing circuitry 1570 executing instructions stored on device readable medium 1580 or memory within processing circuitry 1570. In alternative embodiments, some or all of the functionality may be provided by processing circuitry 1570 without executing instructions stored on a separate or discrete device readable medium, such as in a hard-wired manner. In any of those embodiments, whether executing instructions stored on a device readable storage medium or not, processing circuitry 1570 can be configured to perform the described functionality. The benefits provided by such functionality are not limited to processing circuitry 1570 alone or to other components of network node 1560, but are enjoyed by network node 1560 as a whole, and/or by end users and the wireless network generally.

Device readable medium 1580 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1570. Device readable medium 1580 may store any suitable instructions, data or information, including a computer program, software, an application including one or more of logic, rules, code, tables, etc. and/or other instructions capable of being executed by processing circuitry 1570 and, utilized by network node 1560. Device readable medium 1580 may be used to store any calculations made by processing circuitry 1570 and/or any data received via interface 1590. In some embodiments, processing circuitry 1570 and device readable medium 1580 may be considered to be integrated.

Interface 1590 is used in the wired or wireless communication of signalling and/or data between network node 1560, network 1506, and/or WDs 1510. As illustrated, interface 1590 comprises port(s)/terminal(s) 1594 to send and receive data, for example to and from network 1506 over a wired connection. Interface 1590 also includes radio front end circuitry 1592 that may be coupled to, or in certain embodiments a part of, antenna 1562. Radio front end circuitry 1592 comprises filters 1598 and amplifiers 1596. Radio front end circuitry 1592 may be connected to antenna 1562 and processing circuitry 1570. Radio front end circuitry may be configured to condition signals communicated between antenna 1562 and processing circuitry 1570. Radio front end circuitry 1592 may receive digital data that is to be sent out to other network nodes or WDs via a wireless connection. Radio front end circuitry 1592 may convert the digital data into a radio signal having the appropriate channel and bandwidth parameters using a combination of filters 1598 and/or amplifiers 1596. The radio signal may then be transmitted via antenna 1562. Similarly, when receiving data, antenna 1562 may collect radio signals which are then converted into digital data by radio front end circuitry 1592. The digital data may be passed to processing circuitry 1570. In other embodiments, the interface may comprise different components and/or different combinations of components.

In certain alternative embodiments, network node 1560 may not include separate radio front end circuitry 1592, instead, processing circuitry 1570 may comprise radio front end circuitry and may be connected to antenna 1562 without separate radio front end circuitry 1592. Similarly, in some embodiments, all or some of RF transceiver circuitry 1572 may be considered a part of interface 1590. In still other embodiments, interface 1590 may include one or more ports or terminals 1594, radio front end circuitry 1592, and RF transceiver circuitry 1572, as part of a radio unit (not shown), and interface 1590 may communicate with baseband processing circuitry 1574, which is part of a digital unit (not shown).

Antenna 1562 may include one or more antennas, or antenna arrays, configured to send and/or receive wireless signals. Antenna 1562 may be coupled to radio front end circuitry 1590 and may be any type of antenna capable of transmitting and receiving data and/or signals wirelessly. In some embodiments, antenna 1562 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1562 may be separate from network node 1560 and may be connectable to network node 1560 through an interface or port.

Antenna 1562, interface 1590, and/or processing circuitry 1570 may be configured to perform any receiving operations and/or certain obtaining operations described herein as being performed by a network node. Any information, data and/or signals may be received from a wireless device, another network node and/or any other network equipment. Similarly, antenna 1562, interface 1590, and/or processing circuitry 1570 may be configured to perform any transmitting operations described herein as being performed by a network node. Any information, data and/or signals may be transmitted to a wireless device, another network node and/or any other network equipment.

Power circuitry 1587 may comprise, or be coupled to, power management circuitry and is configured to supply the components of network node 1560 with power for performing the functionality described herein. Power circuitry 1587 may receive power from power source 1586. Power source 1586 and/or power circuitry 1587 may be configured to provide power to the various components of network node 1560 in a form suitable for the respective components (e.g., at a voltage and current level needed for each respective component). Power source 1586 may either be included in, or external to, power circuitry 1587 and/or network node 1560. For example, network node 1560 may be connectable to an external power source (e.g., an electricity outlet) via an input circuitry or interface such as an electrical cable, whereby the external power source supplies power to power circuitry 1587. As a further example, power source 1586 may comprise a source of power in the form of a battery or battery pack which is connected to, or integrated in, power circuitry 1587. The battery may provide backup power should the external power source fail. Other types of power sources, such as photovoltaic devices, may also be used.

Alternative embodiments of network node 1560 may include additional components beyond those shown in FIG. 15 that may be responsible for providing certain aspects of the network node's functionality, including any of the functionality described herein and/or any functionality necessary to support the subject matter described herein. For example, network node 1560 may include user interface equipment to allow input of information into network node 1560 and to allow output of information from network node 1560. This may allow a user to perform diagnostic, maintenance, repair, and other administrative functions for network node 1560.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1510 includes antenna 1511, interface 1514, processing circuitry 1520, device readable medium 1530, user interface equipment 1532, auxiliary equipment 1534, power source 1536 and power circuitry 1537. WD 1510 may include multiple sets of one or more of the illustrated components for different wireless technologies supported by WD 1510, such as, for example, GSM, WCDMA, LTE, NR, WiFi, WiMAX, or Bluetooth wireless technologies, just to mention a few. These wireless technologies may be integrated into the same or different chips or set of chips as other components within WD 1510.

Antenna 1511 may include one or more antennas or antenna arrays, configured to send and/or receive wireless signals, and is connected to interface 1514. In certain alternative embodiments, antenna 1511 may be separate from WD 1510 and be connectable to WD 1510 through an interface or port. Antenna 1511, interface 1514, and/or processing circuitry 1520 may be configured to perform any receiving or transmitting operations described herein as being performed by a WD. Any information, data and/or signals may be received from a network node and/or another WD. In some embodiments, radio front end circuitry and/or antenna 1511 may be considered an interface.

As illustrated, interface 1514 comprises radio front end circuitry 1512 and antenna 1511. Radio front end circuitry 1512 comprise one or more filters 1518 and amplifiers 1516. Radio front end circuitry 1514 is connected to antenna 1511 and processing circuitry 1520, and is configured to condition signals communicated between antenna 1511 and processing circuitry 1520. Radio front end circuitry 1512 may be coupled to or a part of antenna 1511. In some embodiments, WD 1510 may not include separate radio front end circuitry 1512; rather, processing circuitry 1520 may comprise radio front end circuitry and may be connected to antenna 1511. Similarly, in some embodiments, some or all of RF transceiver circuitry 1522 may be considered a part of interface 1514. Radio front end circuitry 1512 may receive digital data that is to be sent out to other network nodes or WDs via a wireless connection. Radio front end circuitry 1512 may convert the digital data into a radio signal having the appropriate channel and bandwidth parameters using a combination of filters 1518 and/or amplifiers 1516. The radio signal may then be transmitted via antenna 1511. Similarly, when receiving data, antenna 1511 may collect radio signals which are then converted into digital data by radio front end circuitry 1512. The digital data may be passed to processing circuitry 1520. In other embodiments, the interface may comprise different components and/or different combinations of components.

Processing circuitry 1520 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1510 components, such as device readable medium 1530, WD 1510 functionality. Such functionality may include providing any of the various wireless features or benefits discussed herein. For example, processing circuitry 1520 may execute instructions stored in device readable medium 1530 or in memory within processing circuitry 1520 to provide the functionality disclosed herein.

As illustrated, processing circuitry 1520 includes one or more of RF transceiver circuitry 1522, baseband processing circuitry 1524, and application processing circuitry 1526. In other embodiments, the processing circuitry may comprise different components and/or different combinations of components. In certain embodiments processing circuitry 1520 of WD 1510 may comprise a SOC. In some embodiments, RF transceiver circuitry 1522, baseband processing circuitry 1524, and application processing circuitry 1526 may be on separate chips or sets of chips. In alternative embodiments, part or all of baseband processing circuitry 1524 and application processing circuitry 1526 may be combined into one chip or set of chips, and RF transceiver circuitry 1522 may be on a separate chip or set of chips. In still alternative embodiments, part or all of RF transceiver circuitry 1522 and baseband processing circuitry 1524 may be on the same chip or set of chips, and application processing circuitry 1526 may be on a separate chip or set of chips. In yet other alternative embodiments, part or all of RF transceiver circuitry 1522, baseband processing circuitry 1524, and application processing circuitry 1526 may be combined in the same chip or set of chips. In some embodiments, RF transceiver circuitry 1522 may be a part of interface 1514. RF transceiver circuitry 1522 may condition RF signals for processing circuitry 1520.

In certain embodiments, some or all of the functionality described herein as being performed by a WD may be provided by processing circuitry 1520 executing instructions stored on device readable medium 1530, which in certain embodiments may be a computer-readable storage medium. In alternative embodiments, some or all of the functionality may be provided by processing circuitry 1520 without executing instructions stored on a separate or discrete device readable storage medium, such as in a hard-wired manner. In any of those particular embodiments, whether executing instructions stored on a device readable storage medium or not, processing circuitry 1520 can be configured to perform the described functionality. The benefits provided by such functionality are not limited to processing circuitry 1520 alone or to other components of WD 1510, but are enjoyed by WD 1510 as a whole, and/or by end users and the wireless network generally.

Processing circuitry 1520 may be configured to perform any determining, calculating, or similar operations (e.g., certain obtaining operations) described herein as being performed by a WD. These operations, as performed by processing circuitry 1520, may include processing information obtained by processing circuitry 1520 by, for example, converting the obtained information into other information, comparing the obtained information or converted information to information stored by WD 1510, and/or performing one or more operations based on the obtained information or converted information, and as a result of said processing making a determination.

Device readable medium 1530 may be operable to store a computer program, software, an application including one or more of logic, rules, code, tables, etc. and/or other instructions capable of being executed by processing circuitry 1520. Device readable medium 1530 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1520. In some embodiments, processing circuitry 1520 and device readable medium 1530 may be considered to be integrated.

User interface equipment 1532 may provide components that allow for a human user to interact with WD 1510. Such interaction may be of many forms, such as visual, audial, tactile, etc. User interface equipment 1532 may be operable to produce output to the user and to allow the user to provide input to WD 1510. The type of interaction may vary depending on the type of user interface equipment 1532 installed in WD 1510. For example, if WD 1510 is a smart phone, the interaction may be via a touch screen; if WD 1510 is a smart meter, the interaction may be through a screen that provides usage (e.g., the number of gallons used) or a speaker that provides an audible alert (e.g., if smoke is detected). User interface equipment 1532 may include input interfaces, devices and circuits, and output interfaces, devices and circuits. User interface equipment 1532 is configured to allow input of information into WD 1510, and is connected to processing circuitry 1520 to allow processing circuitry 1520 to process the input information. User interface equipment 1532 may include, for example, a microphone, a proximity or other sensor, keys/buttons, a touch display, one or more cameras, a USB port, or other input circuitry. User interface equipment 1532 is also configured to allow output of information from WD 1510, and to allow processing circuitry 1520 to output information from WD 1510. User interface equipment 1532 may include, for example, a speaker, a display, vibrating circuitry, a USB port, a headphone interface, or other output circuitry. Using one or more input and output interfaces, devices, and circuits, of user interface equipment 1532, WD 1510 may communicate with end users and/or the wireless network, and allow them to benefit from the functionality described herein.

Auxiliary equipment 1534 is operable to provide more specific functionality which may not be generally performed by WDs. This may comprise specialized sensors for doing measurements for various purposes, interfaces for additional types of communication such as wired communications etc. The inclusion and type of components of auxiliary equipment 1534 may vary depending on the embodiment and/or scenario.

Power source 1536 may, in some embodiments, be in the form of a battery or battery pack. Other types of power sources, such as an external power source (e.g., an electricity outlet), photovoltaic devices or power cells, may also be used. WD 1510 may further comprise power circuitry 1537 for delivering power from power source 1536 to the various parts of WD 1510 which need power from power source 1536 to carry out any functionality described or indicated herein. Power circuitry 1537 may in certain embodiments comprise power management circuitry. Power circuitry 1537 may additionally or alternatively be operable to receive power from an external power source; in which case WD 1510 may be connectable to the external power source (such as an electricity outlet) via input circuitry or an interface such as an electrical power cable. Power circuitry 1537 may also in certain embodiments be operable to deliver power from an external power source to power source 1536. This may be, for example, for the charging of power source 1536. Power circuitry 1537 may perform any formatting, converting, or other modification to the power from power source 1536 to make the power suitable for the respective components of WD 1510 to which power is supplied.

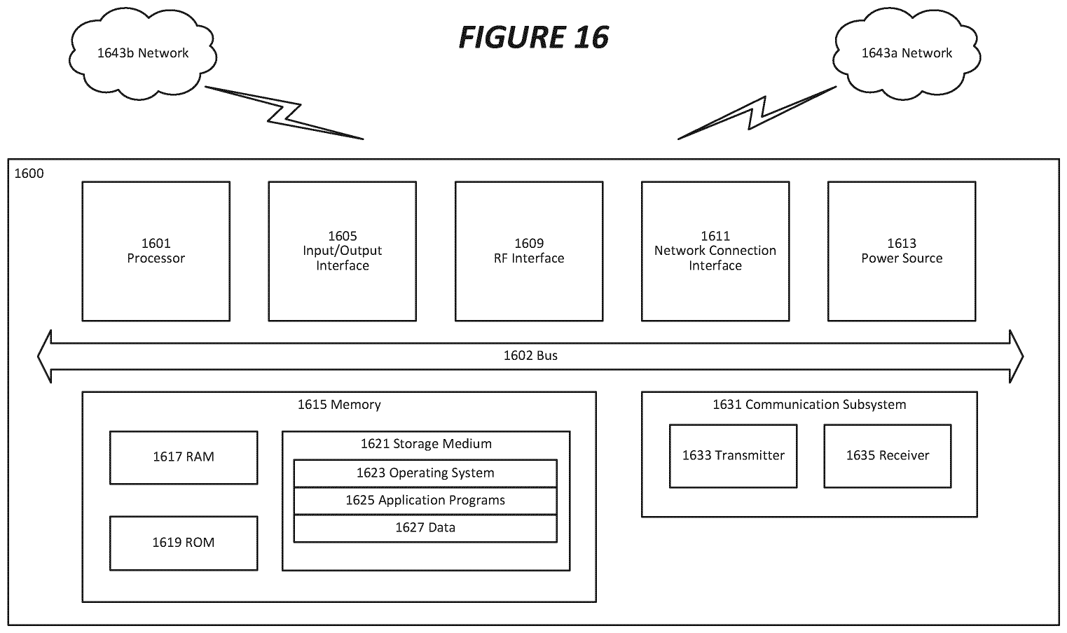

FIG. 16 illustrates a user Equipment in accordance with some embodiments where a leader device and/or a worker node (i.e., a non-leader device) are a user equipment.

FIG. 16 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 16200 may be any UE identified by the 3rd Generation Partnership Project (3GPP), including a NB-IoT UE, a machine type communication (MTC) UE, and/or an enhanced MTC (eMTC) UE. UE 1600, as illustrated in FIG. 16, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 16 is a UE, the components discussed herein are equally applicable to a WD, and vice-versa.

In FIG. 16, UE 1600 includes processing circuitry 1601 that is operatively coupled to input/output interface 1605, radio frequency (RF) interface 1609, network connection interface 1611, memory 1615 including random access memory (RAM) 1617, read-only memory (ROM) 1619, and storage medium 1621 or the like, communication subsystem 1631, power source 1633, and/or any other component, or any combination thereof. Storage medium 1621 includes operating system 1623, application program 1625, and data 1627. In other embodiments, storage medium 1621 may include other similar types of information. Certain UEs may utilize all of the components shown in FIG. 16, or only a subset of the components. The level of integration between the components may vary from one UE to another UE. Further, certain UEs may contain multiple instances of a component, such as multiple processors, memories, transceivers, transmitters, receivers, etc.

In FIG. 16, processing circuitry 1601 may be configured to process computer instructions and data. Processing circuitry 1601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1601 may include two central processing units (CPUs). Data may be information in a form suitable for use by a computer.

In the depicted embodiment, input/output interface 1605 may be configured to provide a communication interface to an input device, output device, or input and output device. UE 1600 may be configured to use an output device via input/output interface 1605. An output device may use the same type of interface port as an input device. For example, a USB port may be used to provide input to and output from UE 1600. The output device may be a speaker, a sound card, a video card, a display, a monitor, a printer, an actuator, an emitter, a smartcard, another output device, or any combination thereof. UE 1600 may be configured to use an input device via input/output interface 1605 to allow a user to capture information into UE 1600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 16, RF interface 1609 may be configured to provide a communication interface to RF components such as a transmitter, a receiver, and an antenna. Network connection interface 1611 may be configured to provide a communication interface to network 1643a. Network 1643a may encompass wired and/or wireless networks such as a local-area network (LAN), a wide-area network (WAN), a computer network, a wireless network, a telecommunications network, another like network or any combination thereof. For example, network 1643a may comprise a Wi-Fi network. Network connection interface 1611 may be configured to include a receiver and a transmitter interface used to communicate with one or more other devices over a communication network according to one or more communication protocols, such as Ethernet, TCP/IP, SONET, ATM, or the like. Network connection interface 1611 may implement receiver and transmitter functionality appropriate to the communication network links (e.g., optical, electrical, and the like). The transmitter and receiver functions may share circuit components, software or firmware, or alternatively may be implemented separately.

RAM 1617 may be configured to interface via bus 1602 to processing circuitry 1601 to provide storage or caching of data or computer instructions during the execution of software programs such as the operating system, application programs, and device drivers. ROM 1619 may be configured to provide computer instructions or data to processing circuitry 1601. For example, ROM 1619 may be configured to store invariant low-level system code or data for basic system functions such as basic input and output (I/O), startup, or reception of keystrokes from a keyboard that are stored in a non-volatile memory. Storage medium 1621 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1621 may be configured to include operating system 1623, application program 1625 such as a web browser application, a widget or gadget engine or another application, and data file 1627. Storage medium 1621 may store, for use by UE 1600, any of a variety of various operating systems or combinations of operating systems.

Storage medium 1621 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1621 may allow UE 1600 to access computer-executable instructions, application programs or the like, stored on transitory or non-transitory memory media, to off-load data, or to upload data. An article of manufacture, such as one utilizing a communication system may be tangibly embodied in storage medium 1621, which may comprise a device readable medium.

In FIG. 16, processing circuitry 1601 may be configured to communicate with network 1643b using communication subsystem 1631. Network 1643a and network 1643b may be the same network or networks or different network or networks. Communication subsystem 1631 may be configured to include one or more transceivers used to communicate with network 1643b. For example, communication subsystem 1631 may be configured to include one or more transceivers used to communicate with one or more remote transceivers of another device capable of wireless communication such as another WD, UE, or base station of a radio access network (RAN) according to one or more communication protocols, such as IEEE 802.16, CDMA, WCDMA, GSM, LTE, UTRAN, WiMax, or the like. Each transceiver may include transmitter 1633 and/or receiver 1635 to implement transmitter or receiver functionality, respectively, appropriate to the RAN links (e.g., frequency allocations and the like). Further, transmitter 1633 and receiver 1635 of each transceiver may share circuit components, software or firmware, or alternatively may be implemented separately.

In the illustrated embodiment, the communication functions of communication subsystem 1631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1631 may include cellular communication, Wi-Fi communication, Bluetooth communication, and GPS communication. Network 1643b may encompass wired and/or wireless networks such as a local-area network (LAN), a wide-area network (WAN), a computer network, a wireless network, a telecommunications network, another like network or any combination thereof. For example, network 1643b may be a cellular network, a Wi-Fi network, and/or a near-field network. Power source 1613 may be configured to provide alternating current (AC) or direct current (DC) power to components of UE 1600.

The features, benefits and/or functions described herein may be implemented in one of the components of UE 1600 or partitioned across multiple components of UE 1600. Further, the features, benefits, and/or functions described herein may be implemented in any combination of hardware, software or firmware. In one example, communication subsystem 1631 may be configured to include any of the components described herein. Further, processing circuitry 1601 may be configured to communicate with any of such components over bus 1602. In another example, any of such components may be represented by program instructions stored in memory that when executed by processing circuitry 1601 perform the corresponding functions described herein. In another example, the functionality of any of such components may be partitioned between processing circuitry 1601 and communication subsystem 1631. In another example, the non-computationally intensive functions of any of such components may be implemented in software or firmware and the computationally intensive functions may be implemented in hardware.

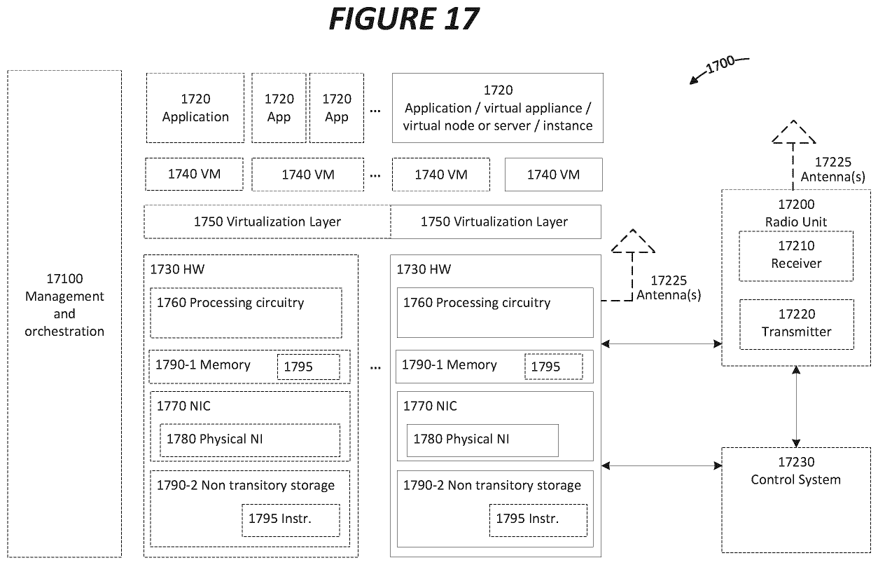

FIG. 17 illustrates a virtualization environment in accordance with some embodiments.

FIG. 17 is a schematic block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1700 hosted by one or more of hardware nodes 1730. Further, in embodiments in which the virtual node is not a radio access node or does not require radio connectivity (e.g., a core network node), then the network node may be entirely virtualized.

The functions may be implemented by one or more applications 1720 (which may alternatively be called software instances, virtual appliances, network functions, virtual nodes, virtual network functions, etc.) operative to implement some of the features, functions, and/or benefits of some of the embodiments disclosed herein. Applications 1720 are run in virtualization environment 1700 which provides hardware 1730 comprising processing circuitry 1760 and memory 1790. Memory 1790 contains instructions 1795 executable by processing circuitry 1760 whereby application 1720 is operative to provide one or more of the features, benefits, and/or functions disclosed herein.

Virtualization environment 1700, comprises general-purpose or special-purpose network hardware devices 1730 comprising a set of one or more processors or processing circuitry 1760, which may be commercial off-the-shelf (COTS) processors, dedicated Application Specific Integrated Circuits (ASICs), or any other type of processing circuitry including digital or analog hardware components or special purpose processors. Each hardware device may comprise memory 1790-1 which may be non-persistent memory for temporarily storing instructions 1795 or software executed by processing circuitry 1760. Each hardware device may comprise one or more network interface controllers (NICs) 1770, also known as network interface cards, which include physical network interface 1780. Each hardware device may also include non-transitory, persistent, machine-readable storage media 1790-2 having stored therein software 1795 and/or instructions executable by processing circuitry 1760. Software 1795 may include any type of software including software for instantiating one or more virtualization layers 1750 (also referred to as hypervisors), software to execute virtual machines 1740 as well as software allowing it to execute functions, features and/or benefits described in relation with some embodiments described herein.

Virtual machines 1740, comprise virtual processing, virtual memory, virtual networking or interface and virtual storage, and may be run by a corresponding virtualization layer 1750 or hypervisor. Different embodiments of the instance of virtual appliance 1720 may be implemented on one or more of virtual machines 1740, and the implementations may be made in different ways.

During operation, processing circuitry 1760 executes software 1795 to instantiate the hypervisor or virtualization layer 1750, which may sometimes be referred to as a virtual machine monitor (VMM). Virtualization layer 1750 may present a virtual operating platform that appears like networking hardware to virtual machine 1740.

As shown in FIG. 17, hardware 1730 may be a standalone network node with generic or specific components. Hardware 1730 may comprise antenna 17225 and may implement some functions via virtualization. Alternatively, hardware 1730 may be part of a larger cluster of hardware (e.g. such as in a data center or customer premise equipment (CPE)) where many hardware nodes work together and are managed via management and orchestration (MANO) 17100, which, among others, oversees lifecycle management of applications 1720.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1740 may be a software implementation of a physical machine that runs programs as if they were executing on a physical, non-virtualized machine. Each of virtual machines 1740, and that part of hardware 1730 that executes that virtual machine, be it hardware dedicated to that virtual machine and/or hardware shared by that virtual machine with others of the virtual machines 1740, forms a separate virtual network elements (VNE).

Still in the context of NFV, Virtual Network Function (VNF) is responsible for handling specific network functions that run in one or more virtual machines 1740 on top of hardware networking infrastructure 1730 and corresponds to application 1720 in FIG. 17.

In some embodiments, one or more radio units 17200 that each include one or more transmitters 17220 and one or more receivers 17210 may be coupled to one or more antennas 17225. Radio units 17200 may communicate directly with hardware nodes 1730 via one or more appropriate network interfaces and may be used in combination with the virtual components to provide a virtual node with radio capabilities, such as a radio access node or a base station.

In some embodiments, some signalling can be effected with the use of control system 17230 which may alternatively be used for communication between the hardware nodes 1730 and radio units 17200.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1×Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CICD Continuous Integration Continuous Deployment
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MB SFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1. A method of generating a federated learning topology including a plurality of worker entities for training a neural network, the method comprising:
generating a plurality of different topologies for a federated learning system, wherein the federated learning system includes a plurality of worker entities;
for respective ones of the plurality of topologies, estimating a cost of operating the federated learning system using the topology;
selecting a subset of the topologies based on the estimated cost;
determining whether the topologies in the selected subset of topologies can be instantiated; and
selecting a topology for implementation based on the determination of whether the topologies in the selected subset of topologies can be instantiated.

2. The computing device of claim 12, wherein estimating the cost of operating the federated learning system using a selected topology comprises estimating a cost of data transfer associated with the selected topology.

3. The computing device of claim 12, wherein estimating the cost of operating the federated learning system using a selected topology comprises estimating a computer performance metric associated with the selected topology.

4. The computing device of claim 3, wherein estimating the computer performance metric comprises estimating, for a layer in the neural network, a number of floating point operations per second, FLOPS, needed based on a scalar product operation on the layer.

5. The computing device of claim 4, wherein estimating the number of FLOPS associated with the selected topology comprises estimating the number of FLOPS according to the following formula for a layer in the neural network:
2*m*N(l+1)*[Nl+1] FLOPS per layer
where m is a number of samples in a data set processed by the neural network and N(l) is a layer size of the neural network.

6. The computing device of claim 12, the operations further comprising:
for selected topologies, generating a network footprint associated with the topology; and
estimating an availability of resources needed to implement the network footprint associated with the topology.

7. The computing device of claim 3, the operations further comprising:
estimating an availability of resources needed to obtain the computer performance metric associated with the selected topology.

8. The computing device of claim 12, wherein the topology comprises one of a centralized training topology, an isolated training topology, a federated training topology, a round robin topology and a hierarchical topology.

9. The computing device of claim 12, the operations further comprising:
determining that the selected topology is no longer sustainable;
selecting a different topology for instantiation; and
instantiating the different topology;
wherein the different topology is selected based on a cost of the different topology and an ability of the different topology to be instantiated.

10. (canceled)

11. The computing device of claim 9, wherein determining that the selected topology is no longer sustainable comprises determining that the selected topology is no longer sustainable based on cost and/or available resources.

12. A computing device, comprising:
a processing circuit; and
a memory coupled to the processing circuit and comprising computer readable program instructions that, when executed by the processing circuit, cause the computing device to perform operations of:
generating a plurality of different topologies for a federated learning system, wherein the federated learning system includes a plurality of worker entities;
for respective ones of the plurality of topologies, estimating a cost of operating the federated learning system using the topology;
selecting a subset of the topologies based on the estimated cost;
determining whether the topologies in the selected subset of topologies can be instantiated; and
selecting a topology for implementation based on the determination of whether the topologies in the selected subset of topologies can be instantiated.

13-46. (canceled)

47. A method of training a neural network at a worker entity in a federated learning system, the method comprising:
receiving a set of model weights from a master entity;
training the neural network model using the set of model weights to obtain a set of modified model weights;
evaluating performance of the model;
determining whether the performance of the model has improved or degraded relative to a previous performance of the model following a previous training round of training neural networks in the federated learning system; and
in response to determining that the performance of the model has improved relative to the previous performance of the model following the previous training rounds, transmitting the modified model weights to the master entity for federation by the master entity and selecting the modified model weights for use in operating the neural network.

48. The federated learning entity of claim 56, wherein evaluating the performance of the model comprises evaluating the performance of the model against local validation data that is local to the worker entity.

49. The federated learning entity of claim 56, the operations further comprising:
in response to determining that the performance of the model has degraded relative to the previous performance of the model following the previous training round, determining whether a level of performance degradation is less than a threshold; and
in response to determining that the level of performance degradation is less than the threshold, transmitting the modified model weights to the master entity for federation by the master entity and selecting the modified model weights for use in operating the neural network.

50. The federated learning entity of claim 56, the operations further comprising:
in response to determining that the level of performance degradation is greater than the threshold, transmitting a previous set of model weights generated in connection with the previous training round to the master entity for federation by the master entity, and selecting the previous set of model weights for use in operating the neural network.

51. The federated learning entity of claim 56, the operations further comprising, in response determining that the level of performance has degraded relative to the previous performance of the model following the previous training round, determining whether or not to participate in future rounds of training neural networks in the federated learning system.

52. The federated learning entity of claim 56, the operations further comprising:
receiving a set of final model weights from the master entity;
evaluating the performance of the neural network using the final model weights;
re-training the neural network starting with the final model weights to obtain modified final model weights;
evaluating the performance of the neural network using the modified final model weights;
comparing performance of the neural network using the final model weights to performance of the neural network using the modified final neural network weights; and
selecting a set of neural network weights from among the final neural network weights and the modified final neural network weights in response to the comparison.

53. The federated learning entity of claim 56, the operations further comprising:
comparing performance of the neural network using the final model weights to performance of the neural network using the modified final neural network weights and intermediate sets of neural network weights generated during a federated learning round; and
selecting a set of neural network weights from among the final neural network weights, the modified final neural network weights and the intermediate neural network weights in response to the comparison.

54. The federated learning entity of claim 56, the operations further comprising:
combining the final neural network weights with the modified final neural network weights and/or one or more sets of intermediate neural network weights to obtain a combined set of neural network weights; and
operating the neural network using the combined set of neural network weights;
wherein combining the first neural network weights with the modified final neural network weights and/or one or more sets of intermediate neural network weights comprises generating a weighted average of the first neural network weights and the modified final neural network weights and/or one or more sets of intermediate neural network weights.

55. (canceled)

56. A federated learning entity, comprising:
a processing circuit; and
a memory coupled to the processing circuit and comprising computer readable program instructions that, when executed by the processing circuit, cause the federated learning entity to perform operations of:
receiving a set of model weights from a master entity;
training the neural network model using the set of model weights to obtain a set of modified model weights;
evaluating performance of the model;
determining whether the performance of the model has improved or degraded relative to a previous performance of the model following a previous training round of training neural networks in the federated learning system; and
in response to determining that the performance of the model has improved relative to the previous performance of the model following the previous training rounds, transmitting the modified model weights to the master entity for federation by the master entity and selecting the modified model weights for use in operating the neural network.

57-58. (canceled)
